(19) United States
(12) Patent Application Publication
(10) Pub. No.: US 2026/0238821 A1
(43) Pub. Date: Aug. 13, 2026

(54) POINT CLOUD ENCODING METHOD, POINT CLOUD DECODING METHOD, AND STORAGE MEDIUM

(71) Applicant: GUANGDONG OPPO MOBILE TELECOMMUNICATIONS CORP., LTD., Dongguan (CN)

(72) Inventors: Chuang MA, Dongguan (CN); Zexing SUN, Dongguan (CN)

(21) Appl. No.: 19/640,220

(22) Filed: Apr. 6, 2026

Related U.S. Application Data
(63) Continuation of application No. PCT/CN2023/123574, filed on Oct. 9, 2023.

(51) Int. Cl. H04N 19/597; H04N 19/105; H04N 19/169; H04N 19/176

(52) U.S. Cl. CPC H04N 19/597; H04N 19/105; H04N 19/176; H04N 19/1883

(57) ABSTRACT

A point cloud decoding method is provided. The method includes the following. At the decoding end, a bitstream is decoded to determine prediction mode indicator information of a current region adaptive hierarchical transform (RAHT) layer. When the prediction mode indicator information indicates that an inter prediction transform decoding mode is to be used for the current RAHT layer, the bitstream is decoded to determine a reference indicator corresponding to the current RAHT layer. A reference unit corresponding to the current RAHT layer is determined from a reference list according to the reference indicator, where the reference list includes K decoded units, and K is an integer greater than or equal to 1. A reference block of a current block in the current RAHT layer is determined according to geometry information of the current block in the current RAHT layer and the reference unit.

### CROSS-REFERENCE TO RELATED APPLICATION(S)

This application is a continuation of International Application No. PCT/CN2023/123574, filed Oct. 9, 2023, the disclosure of which is hereby incorporated by reference in its entirety.

### TECHNICAL FIELD

Embodiments of the disclosure relate to the field of point cloud coding technology, in particular to a point cloud encoding method, a point cloud decoding method, and a storage medium.

### BACKGROUND

In a point cloud compression (PCC) framework, for a geometry-based point cloud compression (G-PCC) coding framework, geometry information of point cloud and attribute information corresponding to each point are encoded separately. Currently, in the G-PCC coding framework, there are three attribute coding methods: predicting transform (PT), lifting transform (LT), and region adaptive hierarchical transform (RAHT). In the first two methods, predictive coding is performed on the point cloud based on the order of level of detail (LOD) generation, and in RAHT, adaptive transform is performed on attribute information from the bottom to the top based on a hierarchy of octree construction.

During region adaptive hierarchical inter prediction transform coding, a previous picture of a current picture is generally used as a reference picture in a point cloud sequence. However, to some extent, the performance of point cloud coding is constrained by the limited reference range.

### SUMMARY

In a first aspect, a decoding method is provided in embodiments of the disclosure. The method is applied to a decoder and includes the following. A bitstream is decoded to determine prediction mode indicator information of a current region adaptive hierarchical transform (RAHT) layer. When the prediction mode indicator information indicates that an inter prediction transform decoding mode is to be used for the current RAHT layer, the bitstream is decoded to determine a reference indicator corresponding to the current RAHT layer. A reference unit corresponding to the current RAHT layer is determined from a reference list according to the reference indicator, where the reference list includes K decoded units, and K is an integer greater than or equal to 1. A reference block of a current block in the current RAHT layer is determined according to geometry information of the current block in the current RAHT layer and the reference unit. An attribute transform value of the current block is determined according to an attribute prediction transform value of the reference block.

In a second aspect, an encoding method is provided in embodiments of the disclosure. The method is applied to an encoder and includes the following. Prediction mode indicator information of a current RAHT layer is determined according to a rate-distortion optimization algorithm, and the prediction mode indicator information is signalled in a bitstream, where the prediction mode indicator information indicates whether an inter prediction transform encoding mode or an intra prediction transform encoding mode is to be used for the current RAHT layer. When the inter prediction transform encoding mode is to be used for the current RAHT layer, a reference unit corresponding to the current RAHT layer is determined from a reference list, a reference indicator corresponding to the current RAHT layer is further determined according to the reference unit, and the reference indicator is signalled in the bitstream. A reference block of a current block in the current RAHT layer is determined according to geometry information of the current block in the current RAHT layer and the reference unit. An attribute transform residual value of the current block is determined according to an attribute prediction transform value of the reference block, and the attribute transform residual value is signalled in the bitstream. The reference list includes K encoded units, and K is an integer greater than or equal to 1.

In a third aspect, a non-transitory computer-readable storage medium is provided in embodiments of the disclosure. The computer-readable storage medium is configured to store a computer program and a bitstream. When executed by one or more processors, the computer program causes the one or more processors to implement the encoding method of the second aspect to generate the bitstream.

### BRIEF DESCRIPTION OF THE DRAWINGS

FIG. 1 is a schematic diagram of a three-dimensional (3D) point cloud picture.

FIG. 2 is a partial enlarged view of a 3D point cloud picture.

FIG. 3 is a schematic diagram illustrating six viewing angles of a point cloud picture.

FIG. 4 is a schematic diagram of a data storage format of a point cloud picture.

FIG. 5 is a schematic diagram of a framework of a geometry-based point cloud compression (G-PCC) encoder.

FIG. 6 is a schematic diagram of a framework of a G-PCC decoder.

FIG. 7 is a schematic diagram illustrating region adaptive hierarchical transform

(RAHT) transform along X, Y, and Z directions.

FIG. 8 is a schematic structural diagram illustrating RAHT transform.

FIG. 9 is a schematic diagram illustrating RAHT forward transform.

FIG. 10 is a schematic diagram illustrating RAHT inverse transform.

FIG. 11 is a schematic structural diagram of an attribute coding block.

FIG. 12 is a schematic diagram of an overall process of RAHT attribute prediction transform coding.

FIG. 13 is a schematic diagram illustrating a neighbourhood prediction relationship of a current block.

FIG. 14 is a schematic diagram illustrating calculation of an attribute transform coefficient.

FIG. 15 is a schematic structural diagram illustrating RAHT attribute inter prediction coding.

FIG. 16 is a schematic diagram of a network architecture of point cloud coding.

FIG. 17 is schematic flowchart 1 illustrating implementation of a point cloud decoding method provided in embodiments of the disclosure.

FIG. 18 is schematic flowchart 2 illustrating implementation of a point cloud decoding method provided in embodiments of the disclosure.

FIG. 19 is schematic flowchart 3 illustrating implementation of a point cloud decoding method provided in embodiments of the disclosure.

FIG. 20 is a schematic flowchart illustrating implementation of a point cloud encoding method provided in embodiments of the disclosure.

FIG. 21 is a schematic diagram illustrating point cloud coding provided in embodiments of the disclosure.

FIG. 22 is schematic structural diagram 1 of an encoder provided in embodiments of the disclosure.

FIG. 23 is schematic structural diagram 2 of an encoder provided in embodiments of the disclosure.

FIG. 24 is schematic structural diagram 1 of a decoder provided in embodiments of the disclosure.

FIG. 25 is schematic structural diagram 2 of a decoder provided in embodiments of the disclosure.

### DETAILED DESCRIPTION

To enable a more detailed understanding of features and technical content in embodiments of the disclosure, the embodiments of the disclosure will be described in detail below in conjunction with the accompanying drawings, which are provided for illustrative purposes only and are not intended to limit embodiments of the disclosure.

Unless otherwise defined, all technical and scientific terms used herein have the same meaning as commonly understood by those skilled in the art. The terms used herein are for the purpose of describing embodiments of the disclosure only and are not intended to limit the disclosure.

In the following description, reference to “some embodiments” describes a subset of all possible embodiments, but it will be understood that “some embodiments” may refer to the same or different subsets of all possible embodiments and may be combined with each other without conflict.

It may be further noted that the terms “first/second/third” in embodiments of the disclosure are merely for distinguishing similar objects and do not imply a particular ordering with respect to the objects, and it will be understood that “first/second/third” may, where appropriate, be interchanged in a particular order or sequence so that embodiments of the disclosure described herein can be implemented in an order other than that illustrated or described herein.

Point cloud is a three-dimensional (3D) representation of the surface of an object. The point cloud (data) of the surface of the object can be collected by means of a collection device such as a photo radar, a lidar, a laser scanner, and a multi-view camera.

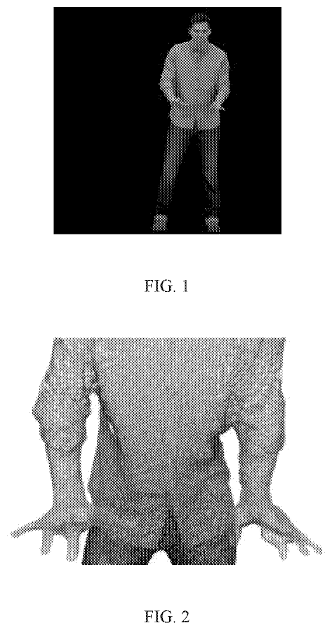

Point cloud is a collection of irregularly-distributed discrete points in space that represent the spatial structure and surface attributes of a 3D object or scene. FIG. 1 illustrates a 3D point cloud picture, and FIG. 2 is a partial enlarged view of a 3D point cloud picture. As can be seen, a surface of the point cloud is composed of densely-distributed points.

Since a two-dimensional picture has information representation at each pixel distributed regularly, position information thereof does not need to be recorded additionally. However, since points in the point cloud are distributed randomly and irregularly in 3D space, a position of each point in the space needs to be recorded, so that the point cloud can be represented completely. Similar to the two-dimensional picture, each position has corresponding attribute information in a collection process, that is, usually a red green blue (RGB) colour value. A colour value reflects a colour of an object. For the point cloud, in addition to colour information, the attribute information corresponding to each point often includes a reflectance value. The reflectance value reflects a surface material of an object. Therefore, a point in the point cloud may include both geometry information and attribute information of the point. For example, the geometry information of the point may be 3D coordinate information (x, y, z) of the point, and thus the geometry information of the point may also be referred to as position information of the point. For example, the attribute information of the point may include colour information (3D colour information) and/or reflectance (one-dimensional reflectance information r), etc. For example, the colour information may be information on any colour space. For example, the colour information may be RGB information, where R represents red, G represents green, and B represents blue. Another example of the colour information may be luminance-chrominance (YCbCr, YUV) information, where Y represents brightness (Luma), Cb (U) represents blue chrominance, and Cr (V) represents red chrominance.

For a point cloud obtained based on laser measurement, a point in the point cloud may include 3D coordinate information of the point and a reflectance value of the point. For a point cloud obtained based on photogrammetry, a point in the point cloud may include 3D coordinate information of the point and 3D colour information of the point. For a point cloud obtained based on laser measurement and photogrammetry, a point in the point cloud may include the 3D coordinate information of the point, the reflectance value of the point, and the 3D colour information of the point.

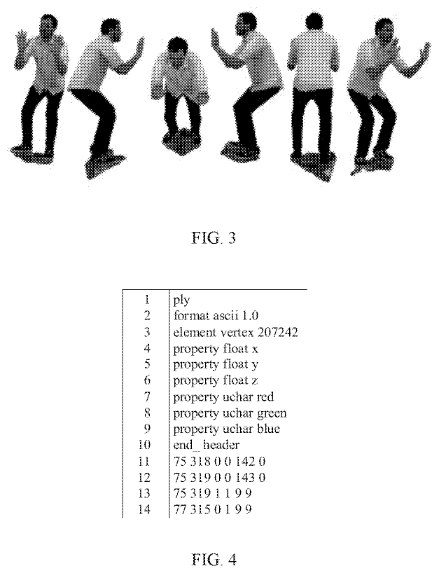

FIG. 3 and FIG. 4 illustrate a point cloud picture and a data storage format of the point cloud picture, respectively. FIG. 3 provides six viewing angles of the point cloud picture. FIG. 4 consists of header information and data. The header information contains a data format, a data representation type, the total point number of the point cloud, and the content represented by the point cloud. For example, the point cloud is in “.ply” format and represented by ASCII codes, with the total point number of 207242. Each point has 3D coordinate information (x, y, z) and 3D colour information (r, g, b).

Point clouds may be classified according to the obtaining manners as:
a static point cloud, i.e., the object is stationary and the point cloud obtaining device is also stationary;
a dynamic point cloud: the object is in motion, but the point cloud obtaining device is stationary; and
a dynamically-obtained point cloud: the point cloud obtaining device is in motion.

For example, point clouds may be classified into two main categories according to usage:
category 1: machine perception point cloud, which may be used in scenarios such as autonomous navigation systems, real-time inspection systems, geographic information systems, visual sorting robots, and rescue and disaster relief robots; and
category 2: human eye perception point cloud, which may be used in scenarios such as digital cultural heritage, free point-of-view broadcasting, 3D immersive communication, and 3D immersive interaction.

The point cloud can represent the spatial structure and surface attributes of the 3D object or scene in a flexible and convenient manner. In addition, since the point cloud is obtained by directly sampling a real object, which can exhibit an extremely realistic effect on the premise of ensuring precision, the point cloud has a wide range of application, including virtual reality games, computer-aided design, geographic information systems, autonomous navigation systems, digital cultural heritage, free point-of-view broadcasting, 3D immersive telepresence, 3D reconstruction of biological tissues and organs, and the like.

The point cloud may be mainly collected in the following ways: computer generation, 3D laser scanning, 3D photogrammetry, and the like. Point cloud of a virtual 3D object or scene may be generated by the computer. Point cloud of a 3D object or scene in a static real world may be obtained through 3D laser scanning, with millions of points obtained every second. Point cloud of a 3D object or scene in a dynamic real world may be obtained through 3D photogrammetry, with tens of millions of points obtained every second. These technologies have reduced the acquisition cost and the time period of point cloud data, and improved the precision of the data. The transformation of the method for acquiring point cloud data makes it possible to acquire a large amount of point cloud data. With an increase in application demand, the processing of massive 3D point cloud data is constrained by storage space and transmission bandwidth.

For example, a point cloud video has a frame rate of 30 frames per second (fps). The number (quantity) of points in each frame of point cloud is 700 thousand. Each point has coordinate information xyz (float) and colour information RGB (uchar). In this case, a 10 s point cloud video has a data volume of approximately 3.15 GB (0.7 million×(4 Byte×3+1 Byte×3)×30 fps×10s=3.15 GB), where 1 Byte corresponds to 10 bit. For a 1280×720 two-dimensional video with a YUV sampling format of 4:2:0 and a frame rate of 24 fps, the data volume of the 10 s video is approximately 0.33 GB (1280×720×12 bit×24 fps×10s~0.33 GB). A 10 s two-view 3D video has a data volume of approximately 0.66 GB (0.33×2=0.66 GB). As can be seen, the data volume of the point cloud video is much greater than the data volume of the two-dimensional video and the data volume of the 3D video with the same duration. Therefore, in order to better achieve data management, save storage space of a server, and reduce transmission traffic and transmission time between the server and a client, point cloud compression has become a key issue to promote the development of point cloud industry.

That is to say, since the point cloud is a collection of massive amounts of points, storing the point cloud not only consumes a lot of memory, but is not conducive to transmission. Also, there is no such large bandwidth available to support the transmission of the point cloud directly across the network layer without compression. Therefore, the point cloud needs to be compressed.

Currently, a point cloud coding framework that can compress the point cloud may be a geometry-based point cloud compression (G-PCC) coding framework or a video-based point cloud compression (V-PCC) coding framework provided by the moving picture experts group (MPEG), or may be an audio video standard (AVS)-PCC coding framework provided by the AVS.

The following will describe the related art by taking the G-PCC coding framework as an example.

It may be understood that, in a point cloud G-PCC coding framework, point cloud data to-be-encoded is first partitioned into multiple slices through slice partitioning. In each slice, geometry information of point cloud and attribute information corresponding to each point are encoded separately.

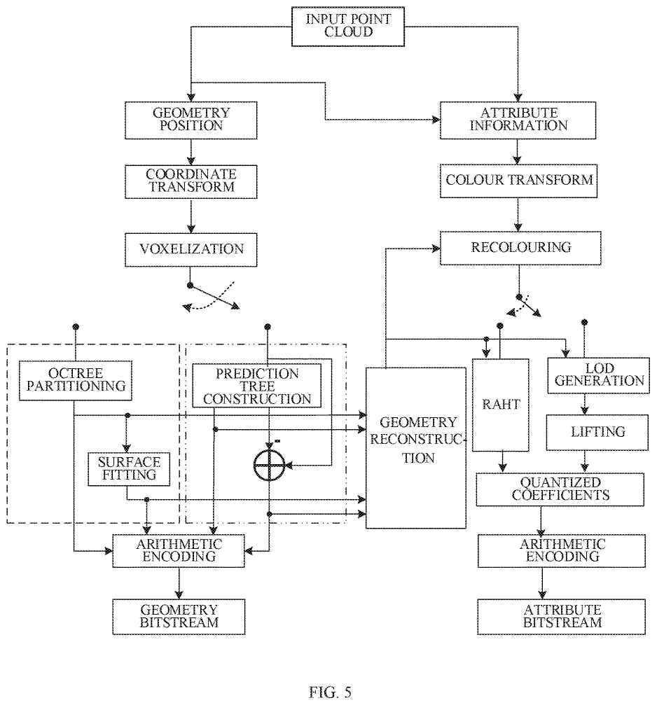

FIG. 5 is a schematic diagram of a framework of a G-PCC encoder. As illustrated in FIG. 5, during geometry encoding, coordinate transform is performed on geometry information, so that the whole point cloud is contained in a bounding box. This is followed by quantization, which is mainly a scaling process. Due to rounding in the quantization, the geometry information of part of the point cloud is the same, and thus whether to remove duplicate points is determined based on parameters. The process of quantization and removal of the duplicate points is also referred to as voxelization. Next, octree partitioning or prediction tree construction is performed on the bounding box. In this process, arithmetic encoding is performed on points in leaf nodes obtained through partitioning, to generate a binary geometry bitstream, or arithmetic encoding (surface fitting based on vertices) is performed on vertices generated through partitioning, to generate a binary geometry bitstream. During attribute encoding, after the geometry encoding is completed and the geometry information is reconstructed, colour transform needs to be performed first, and colour information (namely, attribute information) is transformed from RGB colour space to YUV colour space. Then, the reconstructed geometry information is used to recolour the point cloud, so that the uncoded attribute information can correspond to the reconstructed geometry information. The attribute encoding is mainly performed on colour information. During encoding of the colour information, there are mainly two transform methods. One is distance-based lifting transform which relies on level of detail (LOD) partitioning, and the other is direct region adaptive hierarchical transform (RAHT), both of which transform the colour information from the spatial domain to the frequency domain to obtain high-frequency coefficients and low-frequency coefficients through transform, and finally quantize and encode the coefficients to generate the binary bitstream. Both methods make the colour information be transformed from the spatial domain to the frequency domain, to obtain a high-frequency coefficient and a low-frequency coefficient through transform. Finally, the coefficients are quantized, and then arithmetic encoding is performed on quantized coefficients to generate a binary attribute bitstream.

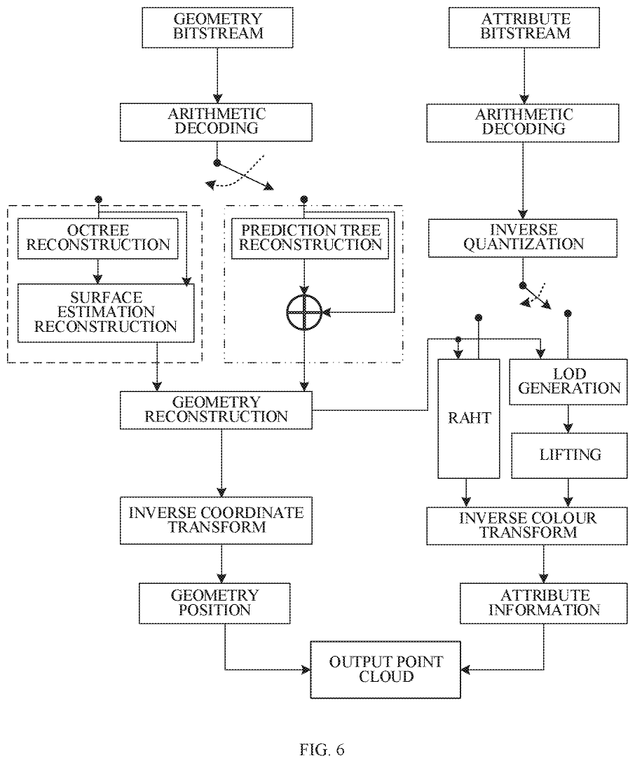

FIG. 6 is a schematic diagram of a framework of a G-PCC decoder. As illustrated in FIG. 6, for an obtained binary bitstream, a geometry bitstream and an attribute bitstream in the binary bitstream are first decoded separately. During decoding of the geometry bitstream, geometry information of the point cloud is obtained through arithmetic decoding-octree reconstruction/prediction tree reconstruction-geometry reconstruction-inverse coordinate transform. During decoding of the attribute bitstream, attribute information of the point cloud is obtained through arithmetic decoding-inverse quantization-LOD partitioning/RAHT-inverse colour transform. Point cloud data to-be-encoded (i.e., output point cloud) is restored based on the geometry information and the attribute information.

It may be noted that as illustrated in FIG. 5 and FIG. 6, currently, the G-PCC geometry coding may be octree geometry coding (indicated by a dashed box) or predictive geometry coding (indicated by a dash-dotted box).

It may be further noted that, currently, in the G-PCC coding framework, there are three attribute coding methods: predicting transform (PT), lifting transform (LT), and RAHT. In the first two methods, predictive coding is performed on the point cloud based on the order of LOD generation, and in RAHT, adaptive transform is performed on attribute information from the bottom to the top based on a hierarchy of octree construction.

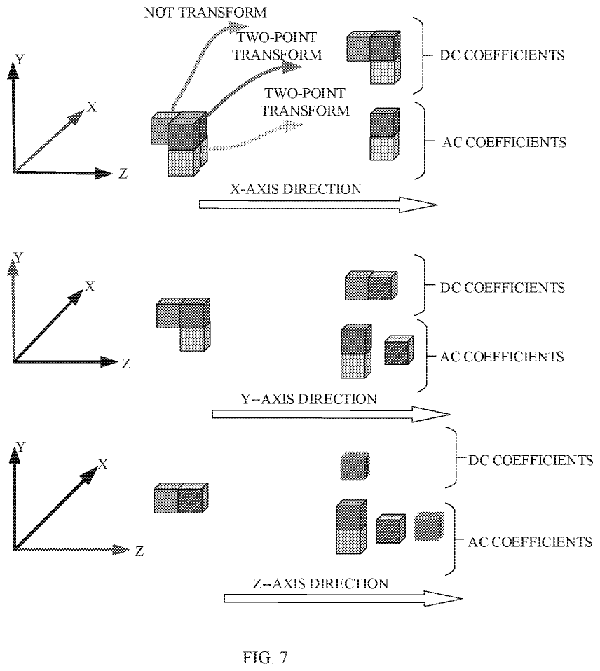

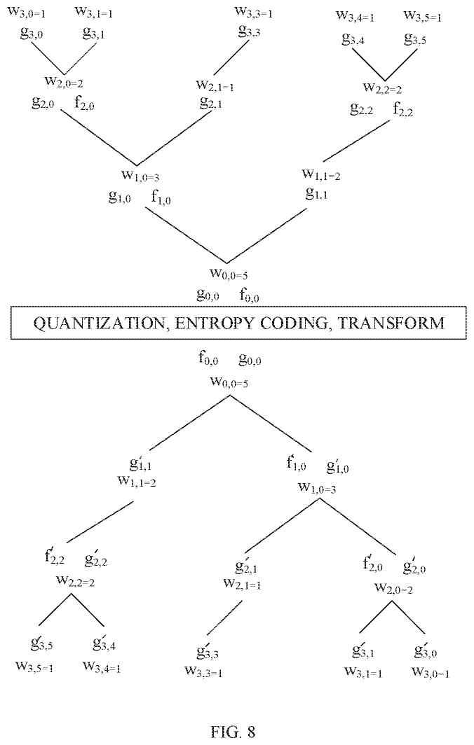

RAHT is a Haar wavelet transform in which attribute information of the point cloud may be transformed from the spatial domain to the frequency domain, further reducing correlation between attributes of the point cloud. The main idea of RAHT is to transform nodes in each layer in x, y, and z dimensions in a bottom-up manner according to an octree structure (as illustrated in FIG. 7), and this process is iterated until a root node of the octree is reached. As illustrated in FIG. 8, the basic idea is to perform wavelet transform based on a hierarchical structure of an octree, associate attribute information with octree nodes, perform recursive transform on attributes of an occupied node(s) in the same parent node in a bottom-up manner, and perform transform on nodes in each layer in x, y, and z dimensions until the root node of the octree is reached. During hierarchical transform, low-pass/low-frequency (DC) coefficients obtained after transform of nodes in the same layer are transmitted to nodes in the next layer for further transform, and all high-pass/high-frequency (AC) coefficients may be encoded using an arithmetic encoder.

In the transform process, transformed DC coefficients (direct-current components) of the nodes in the same layer are transmitted the previous layer for further transform, and transformed AC coefficients (alternating-current components) of each layer are quantized and encoded. The main transform process will be described below.

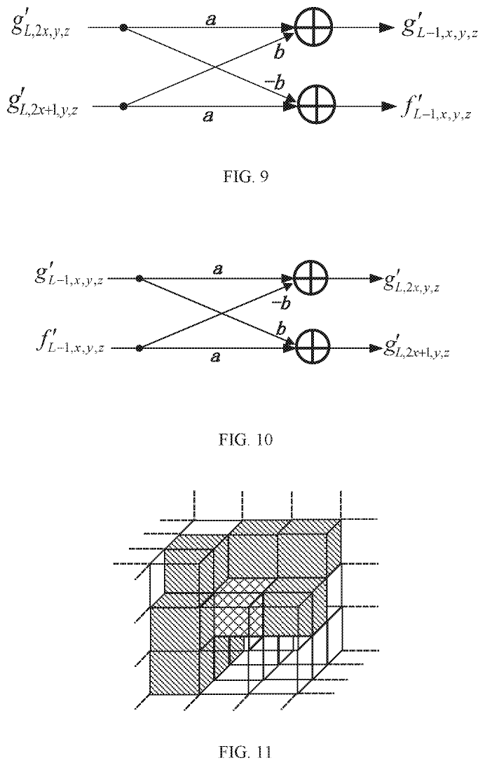

FIG. 9 is a schematic diagram illustrating RAHT forward transform, and FIG. 10 is a schematic diagram illustrating RAHT inverse transform. For the transform and inverse transform processes of RAHT, it is assumed that g′_{L,2x,y,z} and g′_{L,2x+1,y,z} are attribute DC coefficients of two neighbouring points in layer L. After linear transformation, information of layer L−1 includes an AC coefficient f′_{L-1,x,y,z} and a DC coefficient g′_{L-1,x,y,z}. Then, f′_{L-1,x,y,z} is no longer transformed and is directly quantized and encoded. For g′_{L-1,x,y,z}, a nearest neighbour continues to be searched for the transform. If no nearest neighbour is found, g′^{L-1,x,y,z} may be directly transmitted to layer L−2. That is, RAHT transform is valid for only nodes with neighbouring points, and nodes without neighbouring points will be directly transmitted to the previous layer. In the above transform process, if weights (the number of non-empty child nodes in the node) corresponding to g′_{L,2x,y,z} and g′_{L,2x+2,y,z} are respectively w′_{L,2x,y,z} and w′_{L,2x+1,y,z} (respectively abbreviated as w′₀ and w′₁), and a weight corresponding to g′_{L-1,x,y,z} is w′_{L-1,x,y,z}, then the general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 1 )$$

In the above, T_{w0, w1} is a transform matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ \sqrt{{w}_{1}^{′}} & \sqrt{{w}_{0}^{′}}\end{matrix} ] \qquad ( 2 )$$

The transform matrix is adaptively updated based on a weight corresponding to each point. The above process is iteratively updated according to a partitioning structure of an octree until the root node of the octree is reached.

In a specific implementation, for region adaptive hierarchical intra prediction transform coding, prediction may be performed based on RAHT transform coding. As illustrated in FIG. 8, RAHT attribute transform is based on a hierarchical order of an octree, and the transform proceeds from the voxel level until a root node is obtained, thereby completing hierarchical transform coding of the entire attributes. In prediction transform coding, attribute prediction transform coding is also performed based on the hierarchical order of the octree, but the transform proceeds from the root node down to the voxel level. In each RAHT attribute transform process, attribute prediction transform coding is performed based on a 2×2×2 block. Details are illustrated in FIG. 11. As illustrated in FIG. 11, it can be seen that a grid-filled block is a current block to-be-encoded, and blocks filled with diagonal lines are some neighbouring blocks that are coplanar or collinear with the current block to-be-encoded. An attribute of the current block is normalized in the following manner:

$${A}_{node} = {E}_{p ∈ node} attribute ( p ) \qquad ( 3 )$$

$${w}_{node} = {E}_{p ∈ node} 1 = \{ p ∈ node \} \qquad ( 4 )$$

$${a}_{node} = {A}_{node} / {w}_{node} \qquad ( 5 )$$

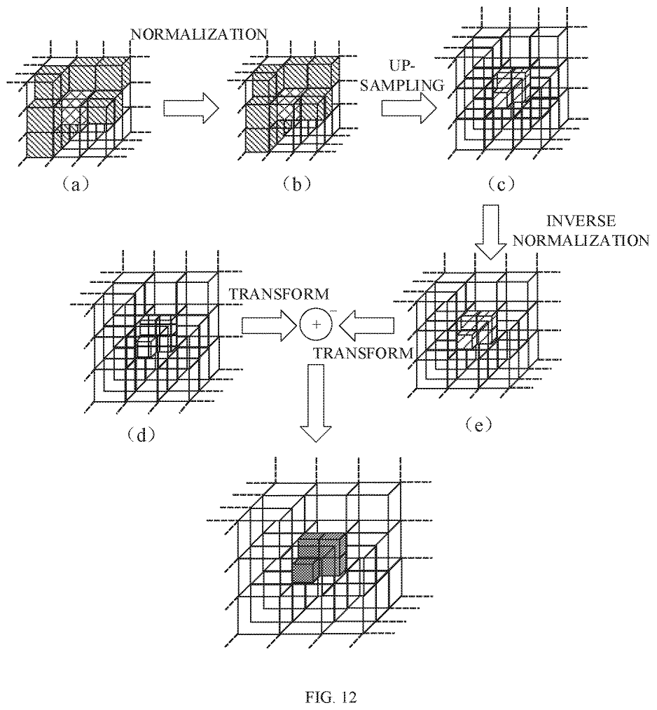

First, the attribute of the current block, i.e., A_{node}, can be obtained based on attributes of points contained in the current block. The attributes of the points contained in the current block are added simply, and then the attribute of the current block is normalized with the number of points in the current block, to obtain an average a_{node} of the attribute of the current block. Attribute transform coding is performed based on the average of the attribute of the current block. For the specific coding process, reference can be made to FIG. 12.

An overall process of RAHT attribute prediction transform coding is illustrated in FIG. 12. Herein, (a) illustrates the current block and some coplanar and collinear neighbouring blocks, (b) illustrates a normalized block, (c) illustrates an up-sampled block, (d) illustrates the attribute of the current block, and (e) illustrates attributes of a prediction block obtained by performing linear weighted fitting based on neighbourhood attributes of the current block. Finally, attribute transform is performed on both (d) and (e) to obtain DC and AC coefficients, and predictive coding is performed on the AC coefficients.

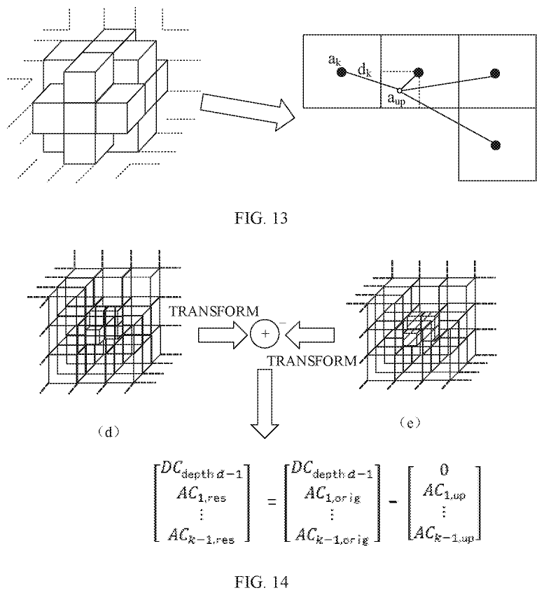

A predicted attribute of the current block can be obtained through linear fitting as illustrated in FIG. 13. As illustrated in FIG. 13, 19 neighbourhood blocks of the current block are first obtained, then linear weighted prediction is performed on an attribute of each sub-block based on spatial geometry distances between the neighbourhood blocks and each sub-block of the current block, and finally, transform is performed based on an attribute of a prediction block obtained through linear weighting. The specific attribute transform is illustrated in FIG. 14. In FIG. 14, (d) represents an original attribute value, and corresponding attribute transform coefficients are as follows:

$$[ \begin{matrix}* \\ {AC}_{1 , orig} \\ ⋮ \\ {AC}_{k - 1 , orig}\end{matrix} ] = {T}_{node} [ \begin{matrix}{A}_{1} , orig / \sqrt{{w}_{1}} \\ ⋮ \\ {A}_{k} , orig / \sqrt{{w}_{k}}\end{matrix} ] \qquad ( 6 )$$

(e) represents an attribute prediction value, and corresponding attribute transform coefficients are as follows:

$$[ \begin{matrix}* \\ {AC}_{1 , up} \\ ⋮ \\ {AC}_{k - 1 , up}\end{matrix} ] = {T}_{node} [ \begin{matrix}{A}_{1 , up} / \sqrt{{w}_{1}} \\ ⋮ \\ {A}_{k , up} / \sqrt{{w}_{k}}\end{matrix} ] \qquad ( 7 )$$

By subtracting the attribute prediction value from the original attribute value, a prediction residual can be obtained as follows:

$$[ \begin{matrix}{DC}_{depth d - 1} \\ {AC}_{1 , res} \\ ⋮ \\ {AC}_{k - 1 , res}\end{matrix} ] = [ \begin{matrix}{DC}_{depth d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 , up}\end{matrix} ] \qquad ( 8 )$$

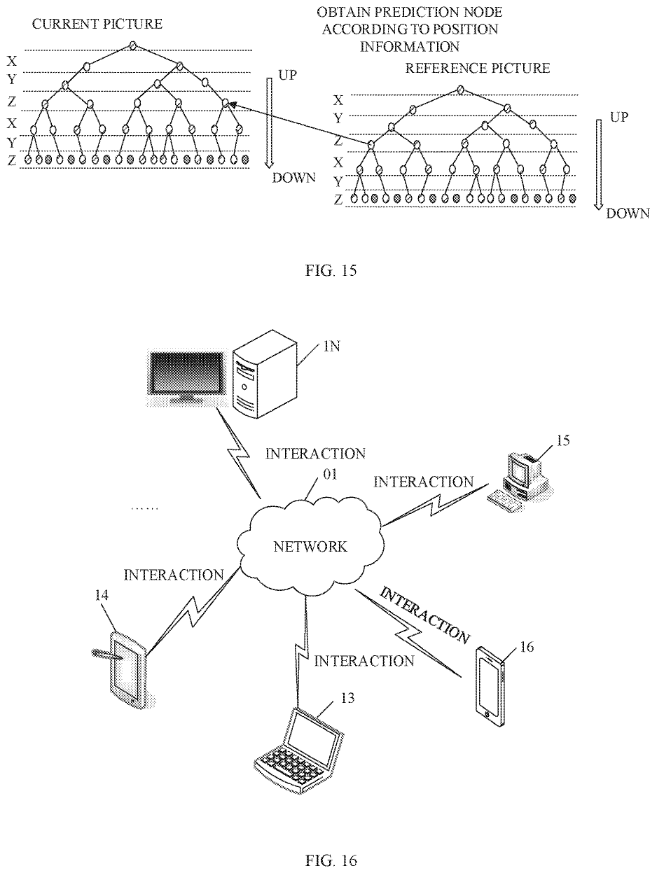

In another specific implementation, for region adaptive hierarchical inter prediction transform coding, in a G-PCC attribute inter prediction coding scheme, similar to intra prediction coding, an RAHT attribute transform coding structure is first constructed based on geometry information. That is, the transform proceeds from the voxel level until a root node is obtained, thereby completing hierarchical transform coding of the entire attributes. In this way, an intra coding structure and an inter coding structure are constructed. An RAHT attribute inter coding structure may be illustrated in FIG. 15.

As illustrated in FIG. 15, a collocated prediction node of a current node to-be-encoded is first obtained in a reference picture (also referred to as a reference frame) based on geometry information of the node to-be-encoded, and then a predicted attribute of the current node to-be-encoded is obtained based on geometry information and attribute information of a reference node.

An attribute prediction value of the current node to-be-encoded is obtained in the following two different manners.
\textcircled{1} If an inter prediction node of the current node is valid, that is, the collocated node exists, then an attribute of the prediction node is directly used as the attribute prediction value of the current node to-be-encoded.
\textcircled{2} If an inter prediction node of the current node is invalid, that is, no collocated node exists, then an attribute prediction value of an intra neighbouring node is used as the attribute prediction value of the node to-be-encoded.

Finally, the obtained attribute prediction value is used to predict an attribute of the current node to-be-encoded, thereby completing predictive coding of the entire attributes.

In yet another specific implementation, for adaptive region adaptive hierarchical inter/intra prediction transform coding, for each RAHT transform layer, at the encoding end, codewords required for simply applying region adaptive hierarchical intra prediction transform coding to a current layer as well as codewords required for simply applying region adaptive hierarchical inter prediction transform coding to the current layer are first calculated, a mode with smaller rate-distortion is selected, and a flag is encoded.

Accordingly, at the decoding end, the flag is decoded to obtain the mode. If the selected mode is region adaptive hierarchical intra prediction transform coding, the decoding end adopts region adaptive hierarchical intra prediction transform coding. If the selected mode is region adaptive hierarchical inter prediction transform coding, the decoding end adopts region adaptive hierarchical inter prediction transform coding.

However, in common technologies, during region adaptive hierarchical inter prediction transform coding, a reference picture in a point cloud sequence is merely a previous picture of a current picture, and due to the limited reference range, the performance is limited.

To solve the above problem, a point cloud encoding method and a point cloud decoding method are provided in embodiments of the disclosure. At the decoding end, a bitstream is decoded to determine prediction mode indicator information of a current RAHT layer. When the prediction mode indicator information indicates that an inter prediction transform decoding mode is to be used for the current RAHT layer, the bitstream is decoded to determine a reference indicator corresponding to the current RAHT layer. A reference unit corresponding to the current RAHT layer is determined from a reference list according to the reference indicator, where the reference list includes K decoded units, and K is an integer greater than or equal to 1. A reference block of a current block in the current RAHT layer is determined according to geometry information of the current block in the current RAHT layer and the reference unit. An attribute transform value of the current block is determined according to an attribute prediction transform value of the reference block. At the encoding end, prediction mode indicator information of a current RAHT layer is determined according to a rate-distortion optimization algorithm, and the prediction mode indicator information is signalled in a bitstream, where the prediction mode indicator information indicates whether an inter prediction transform encoding mode or an intra prediction transform encoding mode is to be used for the current RAHT layer. When the inter prediction transform encoding mode is to be used for the current RAHT layer, a reference unit corresponding to the current RAHT layer is determined from a reference list, a reference indicator corresponding to the current RAHT layer is further determined according to the reference unit, and the reference indicator is signalled in the bitstream. A reference block of a current block in the current RAHT layer is determined according to geometry information of the current block in the current RAHT layer and the reference unit. An attribute transform residual value of the current block is determined according to an attribute prediction transform value of the reference block, and the attribute transform residual value is signalled in the bitstream. The reference list includes K encoded units, and K is an integer greater than or equal to 1. That is to say, in embodiments of the disclosure, in terms of using the inter prediction transform decoding mode for the current RAHT layer, the reference unit corresponding to the current RAHT layer may be determined according to the reference list, and the reference block of the current block is determined from the reference unit. Since the constructed reference list includes multiple decoded units, reference can be made to more attribute prediction information during inter attribute prediction for the current RAHT layer, so that the attribute transform value of the current block, determined based on the reference block, can be made more accurate, thereby improving the prediction effect of attribute information and the performance of point cloud compression.

It may be understood that, a network architecture of a point cloud coding system including a decoding method and an encoding method is provided in embodiments of the disclosure. FIG. 16 is a schematic diagram of a network architecture of point cloud coding. As illustrated in FIG. 16, the network architecture includes one or more electronic devices 13 to IN and a communication network 01. The electronic devices 13 to IN can perform video interaction through the communication network 01. The electronic device may be various types of devices having point cloud coding functions during implementation. For example, the electronic device may include a mobile phone, a tablet computer, a personal computer, a personal digital assistant, a navigator, a digital phone, a video phone, a television, a sensing device, a server, etc., which is not limited in embodiments of the disclosure

The decoder or the encoder in embodiments of the disclosure may be the above electronic device. That is to say, the electronic devices in embodiments of the disclosure have a point cloud coding function, and generally include a point cloud encoder (namely, an encoder) and a point cloud decoder (namely, a decoder).

Embodiments of the disclosure will be elaborated below with reference to the accompanying drawings.

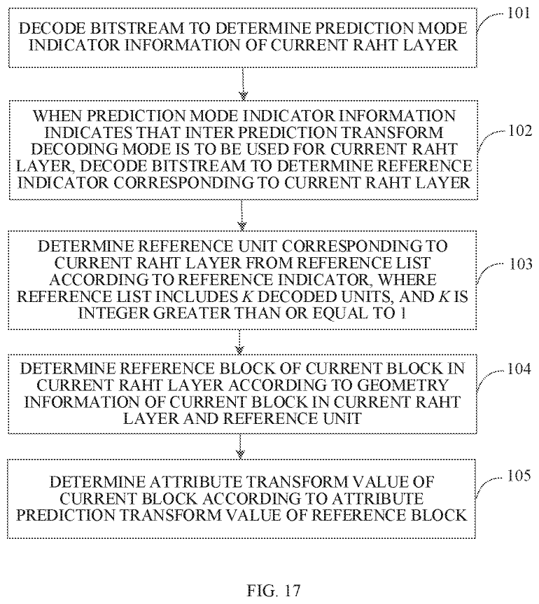

In an embodiment of the disclosure, reference is made to FIG. 17 which is a schematic flowchart of a decoding method provided in embodiments of the disclosure. As illustrated in FIG. 17, a point cloud decoding method performed by a decoder may include the following.

At 101, a bitstream is decoded to determine prediction mode indicator information of a current RAHT layer.

In embodiments of the disclosure, the prediction mode indicator information of the current RAHT layer may be first determined.

It may be noted that, the decoding method in embodiments of the disclosure is applied to a point cloud decoder (also referred to as “decoder” for short). The method may refer to the point cloud decoding method, specifically, a point cloud attribute decoding method.

It may be noted that in embodiments of the disclosure, during RAHT attribute transform, the order of RAHT attribute transform is that the partitioning proceeds from a root node in sequence to the voxel level, specifically, the partitioning is stopped when 1×1×1 unit cube is obtained, thereby completing coding and reconstruction of the entire point cloud attributes. Herein, a layer obtained by performing one down-sampling along the Z direction, the Y direction, and the X direction each time is an RAHT transform layer, i.e., layer. Then, when a 1×1×1 unit cube is obtained, it indicates that the partitioning arrives at the voxel level.

It may be understood that in embodiments of the disclosure, the current RAHT layer may be an RAHT transform layer corresponding to a current point cloud.

Further, in embodiments of the disclosure, the prediction mode indicator information of the current RAHT layer may be used for determining a prediction mode to be used for the current RAHT layer. The prediction mode for the current RAHT layer may include an inter prediction transform decoding mode and an intra prediction transform decoding mode.

It may be understood that in embodiments of the disclosure, if the prediction mode for the current RAHT layer is the intra prediction transform decoding mode, a prediction mode for any transform block in the current RAHT layer is the intra prediction transform decoding mode. That is to say, the intra prediction transform decoding mode may be applied to all of transform blocks in the current RAHT layer.

It may be understood that in embodiments of the disclosure, if the prediction mode for the current RAHT layer is the inter prediction transform decoding mode, a prediction mode for at least one transform block in the current RAHT layer is the inter prediction transform decoding mode. That is to say, the inter prediction transform decoding mode may be applied to all of transform blocks in the current RAHT layer or may be applied to part of transform blocks in the current RAHT layer.

Further, in embodiments of the disclosure, in terms of determining the prediction mode for the current RAHT layer, the bitstream may be decoded to determine the prediction mode indicator information of the current RAHT layer, and then the prediction mode for the current RAHT layer is determined according to the prediction mode indicator information.

It may be noted that in embodiments of the disclosure, the prediction mode indicator information of the current RAHT layer may be a syntax element corresponding to attribute header information (also referred to as attribute header).

Exemplarily, in some embodiments, the prediction mode indicator information may be placed in an array of a vector form in the attribute header. Each RAHT layer corresponds to one prediction mode indicator information. For example, if a current point cloud corresponds to 10 RAHT layers, then 10 prediction mode indicator information need to be correspondingly included in this vector.

Exemplarily, in some embodiments, the prediction mode indicator information may be determined based on an attribute header corresponding to a slice, or may be determined based on an attribute header corresponding to a frame. This disclosure is not limited in this regard.

It may be understood that in embodiments of the disclosure, the current RAHT layer may be any RAHT transform layer corresponding to a current point cloud, and accordingly, a prediction mode for the current RAHT layer may be determined according to the prediction mode indicator information of the current RAHT layer.

It may be noted that in embodiments of the disclosure, in terms of determining the prediction mode for the current RAHT layer according to the prediction mode indicator information, a value of the prediction mode indicator information may be first determined, and then the prediction mode for the current RAHT layer is further determined according to the value of the prediction mode indicator information.

Exemplarily, in some embodiments, when the value of the prediction mode indicator information is a first value, it is determined that the prediction mode indicator information indicates that an intra prediction transform decoding mode is to be used for the current RAHT layer, that is, the prediction mode for the current RAHT layer is the intra prediction transform decoding mode. When the value of the prediction mode indicator information is a second value, it is determined that the prediction mode indicator information indicates that an inter prediction transform decoding mode is to be used for the current RAHT layer, that is, the prediction mode for the current RAHT layer is the inter prediction transform decoding mode.

It may be further noted that in embodiments of the disclosure, the first value is different from the second value, and the first value and the second value may be in parameter form or in numerical form. Specifically, first prediction mode indicator information and second prediction mode indicator information may be parameters written in a profile, or may be a value of a flag, which is not limited herein. In addition, for the first value and the second value, the first value may be set to 1 and the second value may be set to 0; or, the first value may be set to 0 and the second value may be set to 1; or, the first value may be set to true and the second value may be set to false; or, the first value may be set to false and the second value may be set to true. In embodiments of the disclosure, the first value is set to 0 and the second value is set to 1, which is not limited herein.

At 102, when the prediction mode indicator information indicates that an inter prediction transform decoding mode is to be used for the current RAHT layer, the bitstream is decoded to determine a reference indicator corresponding to the current RAHT layer.

In embodiments of the disclosure, after the prediction mode indicator information of the current RAHT layer is determined, when the prediction mode indicator information indicates that the inter prediction transform decoding mode is to be used for the current RAHT layer, the bitstream may be further decoded to determine the reference indicator corresponding to the current RAHT layer.

It may be noted that in embodiments of the disclosure, the reference indicator may be used for determining a decoded reference unit corresponding to the current RAHT layer.

At 103, a reference unit corresponding to the current RAHT layer is determined from a reference list according to the reference indicator, where the reference list includes K decoded units, and K is an integer greater than or equal to 1.

In embodiments of the disclosure, if the prediction mode indicator information indicates that the inter prediction transform decoding mode is to be used for the current RAHT layer, then after the reference indicator corresponding to the current RAHT layer is determined, the reference unit corresponding to the current RAHT layer may be further determined from the reference list according to the reference indicator.

It may be noted that in embodiments of the disclosure, the reference list may include K decoded units. K is an integer greater than or equal to 1.

It may be understood that in embodiments of the disclosure, a decoded unit may at least include any one of a decoded picture, a block corresponding to the decoded picture, or a slice corresponding to the decoded picture. Accordingly, the K decoded units at least include: K decoded pictures corresponding to a current picture, or K blocks corresponding to the K decoded pictures, or K slices corresponding to the K decoded pictures.

Exemplarily, in some embodiments, the reference list may include K pictures of a point cloud sequence decoded prior to a current picture. That is, the reference list includes K decoded pictures corresponding to the current picture.

Exemplarily, in some embodiments, the reference list may include K blocks corresponding to a block where a current block is located, in K pictures of a point cloud sequence decoded prior to a current picture. That is, the reference list includes K blocks to which K decoded pictures corresponding to the current picture correspond.

Exemplarily, in some embodiments, the reference list may include K slices corresponding to a block where a current block is located, in K pictures of a point cloud sequence decoded prior to a current picture. That is, the reference list includes K slices to which K decoded pictures corresponding to the current picture correspond.

Further, in embodiments of the disclosure, the K decoded units at least include: N decoded pictures corresponding to the current picture and a fused picture generated based on the N decoded pictures, or N blocks corresponding to the N decoded pictures and a fused block generated based on the N blocks, or N slices corresponding to the N decoded pictures and a fused slice generated based on the N slices. Nis greater than 0 and less than or equal to K.

That is to say, in embodiments of the disclosure, K pictures/slices/blocks in the reference list are not limited to only the first K pictures/slices/blocks corresponding to the current picture, and may also include the first N pictures/slices/blocks corresponding to the current picture as well as a fused picture/slice/block generated based on the first N pictures/slices/blocks.

It may be noted that in embodiments of the disclosure, based on the first N decoded pictures/slices/blocks, one picture/slice/block thereof is selected, nearest points are selected in N−1 pictures/slices/blocks other than the one picture/slice/block, and geometry values and attribute values are respectively averaged to obtain a new fused picture/slice/block. For the selection of the nearest point, any one of a nearest point under spatial Morton code distance, a nearest point under spatial Hilbert code distance, or a nearest point under spatial Manhattan distance may be included at least.

Exemplarily, in some embodiments, it is assumed that the first three decoded units corresponding to the current RAHT layer are A0, A1, and A2 respectively, where A0 indicates the 0th picture/slice/block, A1 indicates the 1st picture/slice/block, and A2 indicates the 2nd picture/slice/block. One implementation of a reference list corresponding to the current RAHT layer may be to include these three decoded units A0, A1, and A2. Another implementation of the reference list corresponding to the current RAHT layer may be to include two decoded units A0 and A, where A is a new fused picture/slice/block generated by fusing A1 and A2.

Further, in embodiments of the disclosure, the K decoded units at least include: the fused picture generated based on the N decoded pictures corresponding to the current picture, or the fused block generated based on the N blocks corresponding to the N decoded pictures, or the fused slice generated based on the N slices corresponding to the N decoded pictures. Nis greater than 0 and less than or equal to K.

It may be noted that in embodiments of the disclosure, in terms of generating the fused picture/slice/block based on the N pictures/slices/blocks, the fused picture/slice/block may be determined according to geometry information and/or attribute information of the N pictures/slices/blocks.

It may be understood that in embodiments of the disclosure, based on the first N decoded pictures/slices/blocks, one picture/slice/block thereof is selected, geometry information of the one picture/slice/block is retained as geometry information of a new fused picture/slice/block, and attribute information of the new fused picture/slice/block may be determined according to attribute information of the first N pictures/slices/blocks.

It may be understood that in embodiments of the disclosure, based on the first N decoded pictures/slices/blocks, one picture/slice/block thereof is selected, and attribute information of the one picture/slice/block is retained as attribute information of a new fused picture/slice/block, and geometry information of the new fused picture/slice/block may be determined according to geometry information of the first N pictures/slices/blocks.

It may be understood that in embodiments of the disclosure, based on the first N decoded pictures/slices/blocks, geometry information of a new fused picture/slice/block may be determined according to geometry information of the first N pictures/slices/blocks, and attribute information of the new fused picture/slice/block may be determined according to attribute information of the first N pictures/slices/blocks.

It may be understood that in embodiments of the disclosure, when K is greater than 1, pictures, blocks, or slices for reference during inter attribute prediction for a transform block in the current RAHT layer are no longer limited to only a previous picture of the current picture, and may include a wider selection range of other decoded pictures.

It may be noted that in embodiments of the disclosure, the number K of decoded units may be determined according to a preset threshold.

That is to say, in embodiments of the disclosure, the number K of decoded units in the reference list is not infinite, and the number K of decoded units may be limited by the preset threshold.

Exemplarily, in some embodiments, if the number K of decoded units in the reference list reaches a certain threshold, for example, a preset threshold, then the first added one may be discarded, and the next one may be filled, to maintain a range that does not exceed the preset threshold.

Exemplarily, in some embodiments, if the number K of decoded units in the reference list reaches a certain threshold, for example, a preset threshold, then the reference list may be directly reset to 0 and then accumulated again.

Further, in embodiments of the disclosure, the reference list may correspond to the current RAHT layer, and the reference list may be constructed while performing prediction on attribute information of the current RAHT layer.

It may be noted that in embodiments of the disclosure, an arrangement order and a traversal order of decoded units in the reference list are not limited in the disclosure. That is to say, during attribute prediction for the current RAHT layer, for the decoded units in the constructed reference list, reference can be made to a partitioning order of an RAHT layer or any other order.

Further, in embodiments of the disclosure, when the prediction mode indicator information indicates that the inter prediction transform decoding mode is to be used for the current RAHT layer, the bitstream may be further decoded to determine a reference index corresponding to the current RAHT layer.

It may be noted that in embodiments of the disclosure, the reference index may be used for determining an index (or order number) of a decoded unit in the reference list corresponding to the current RAHT layer.

It may be understood that in embodiments of the disclosure, since an order of the decoded unit in the reference list is not limited, a corresponding reference index may be used for determining the index of the decoded unit in the reference list.

It may be noted that in embodiments of the disclosure, the index of the decoded unit may indicate an absolute decoding order or a relative decoding order of the decoded unit.

Exemplarily, in some embodiments, assuming that a decoded unit is a decoded picture, an index of the decoded unit may indicate an absolute order of the decoded picture or may indicate a relative order between the decoded picture and the current picture.

That is to say, in embodiments of the disclosure, a reference picture list serves two purposes. One is to store a display order (i.e., an absolute order) of a reference picture, that is, directly store an absolute value of the display order. The other is to store a relative order of the reference picture, that is, store a difference in display orders between the reference picture and the current picture.

Further, in embodiments of the disclosure, the bitstream is decoded to determine prediction mode indicator information of a current decoding unit, where the current decoding unit includes the current RAHT layer, a current picture, a slice in the current picture, or a block in the current picture. When the prediction mode indicator information indicates that the inter prediction transform decoding mode is to be used for the current decoding unit, the bitstream may be further decoded to determine a reference index corresponding to the current RAHT layer.

That is to say, in embodiments of the disclosure, the decoding of the index of the decoded unit in the reference list may be performed not only for the current RAHT layer but also for the current picture, the slice in the current picture, or the block in the current picture. This disclosure is not limited in this regard.

Further, in embodiments of the disclosure, in terms of determining the reference unit corresponding to the current RAHT layer from the reference list according to the reference indicator, when a value of the reference indicator is i, the i-th decoded unit in the reference list is determined as the reference unit, where i is an integer less than or equal to K.

It may be understood that in embodiments of the disclosure, the reference indicator corresponding to the current RAHT layer may be used for determining the reference unit corresponding to the current RAHT layer. According to the reference indicator, an order and position of a corresponding reference unit in the reference list may be determined.

Further, in embodiments of the disclosure, in terms of determining the reference unit corresponding to the current RAHT layer from the reference list according to the reference indicator, when a value of the reference indicator is i, the i-th decoded unit before the current picture in the reference list is determined as the reference unit, where i is an integer less than or equal to K.

It may be understood that in embodiments of the disclosure, the reference indicator corresponding to the current RAHT layer may be used for determining the reference unit corresponding to the current RAHT layer. According to the reference indicator, a relationship between the reference unit corresponding to the current RAHT layer in the reference list and the current picture may be determined.

At 104, a reference block of a current block in the current RAHT layer is determined according to geometry information of the current block in the current RAHT layer and the reference unit.

In embodiments of the disclosure, after the reference unit corresponding to the current RAHT layer is determined from the reference list according to the reference indicator, the reference block of the current block in the current RAHT layer may be further determined according to the geometry information of the current block in the current RAHT layer and the reference unit.

It may be noted that in embodiments of the disclosure, if it is determined based on the prediction mode indicator information that the inter prediction transform decoding mode is to be used for the current RAHT layer, then a reference block of a current block to-be-decoded in the current RAHT layer may be further determined according to geometry information of the current block to-be-decoded in the current RAHT layer and the reference unit corresponding to the current RAHT layer.

It may be understood that in embodiments of the disclosure, the current block may be a transform block to-be-decoded in the current RAHT layer.

Further, in embodiments of the disclosure, in terms of determining the reference block of the current block in the current RAHT layer according to the geometry information of the current block in the current RAHT layer and the reference unit, the reference block may be determined, based on the geometry information of the current block, from the reference unit according to a preset search strategy.

It may be noted that in embodiments of the disclosure, the geometry information at least includes any one of: spatial Morton code information, spatial Hilbert code information, spatial coordinate information, spherical coordinate information, or polar coordinate information.

It may be noted that in embodiments of the disclosure, the preset search strategy may be used for searching for and determining an inter reference transform block. The preset search strategy may include any search method for a transform block.

It may be understood that in embodiments of the disclosure, in terms of determining the reference block, search processing may be performed on the reference unit corresponding to the current RAHT layer according to the preset search strategy.

Further, in embodiments of the disclosure, in terms of determining, based on the geometry information of the current block, the reference block from the reference unit according to the preset search strategy, first position information may be first determined according to the geometry information of the current block; and then the reference block may be determined, based on the first position information, from the reference unit according to the preset search strategy.

It may be noted that in embodiments of the disclosure, the first position information may at least include: the geometry information of the current block, and/or geometry information of a parent block of the current block corresponding to the current block, and/or occupancy information of the current block, and/or occupancy information of the parent block of the current block.

That is to say, in embodiments of the disclosure, in terms of determining the reference block, search processing may be performed based on one or more of the geometry information of the current block, the geometry information of the parent block of the current block, the occupancy information of the current block, or the occupancy information of the parent block of the current block.

It may be noted that in embodiments of the disclosure, the preset search strategy at least includes: searching, in the reference unit, for a transform block whose geometry information is the same as the geometry information of the current block, and determining the transform block as the reference block; and/or, searching, in the reference unit, for a parent transform block whose geometry information is the same as the geometry information of the parent block of the current block, and determining the parent transform block as the reference block; and/or, searching, in the reference unit, for a transform block whose geometry information is the same as the geometry information of the current block and whose occupancy information satisfies a first correlation condition with the occupancy information of the current block, and determining the transform block as the reference block; and/or, searching, in the reference unit, for a transform block whose geometry information is the same as the geometry information of the current block and occupancy information of whose corresponding parent transform block satisfies a second correlation condition with the occupancy information of the parent block of the current block, and determining the transform block as the reference block; and/or, searching, in the reference unit, for a transform block whose geometry information is the same as the geometry information of the parent block of the current block and whose occupancy information satisfies the first correlation condition with the occupancy information of the current block, and determining the transform block as the reference block; and/or, searching, in the reference unit, for a parent transform block whose geometry information is the same as the geometry information of the parent block of the current block and whose occupancy information satisfies the second correlation condition with the occupancy information of the parent block of the current block, and determining the parent transform block as the reference block.

It may be noted that in embodiments of the disclosure, the first correlation condition includes: an absolute value of a difference between the occupancy information of the current block and the occupancy information of the transform block being less than or equal to a first threshold. The first threshold is greater than or equal to 0 and less than or equal to 8.

It may be noted that in embodiments of the disclosure, the second correlation condition includes: an absolute value of a difference between the occupancy information of the parent block of the current block and the occupancy information of the parent transform block being less than or equal to a second threshold. The second threshold is greater than or equal to 0 and less than or equal to 8.

Exemplarily, in some embodiments, in terms of searching for the reference block based on the preset search strategy, a transform block whose geometry position (geometry information) is the same as a geometry position of a current transform block (a current block), found in a reference picture/block/slice (a decoded unit), may be selected as a corresponding reference block.

Exemplarily, in some embodiments, in terms of searching for the reference block based on the preset search strategy, a transform block whose parent transform block has the same geometry position as a parent transform block of a current transform block (a parent block of a current block), found in a reference picture/block/slice, may be selected as a corresponding reference block.

Exemplarily, in some embodiments, in terms of searching for the reference block based on the preset search strategy, a transform block whose geometry position is the same as a geometry position of a current transform block and whose occupancy information has a difference from occupancy information of the current transform block less than or equal to J (a first threshold), found in a reference picture/block/slice, may be selected as a corresponding reference block (where J ranges from 0 to 8).

Exemplarily, in some embodiments, in terms of searching for the reference block based on the preset search strategy, a transform block whose geometry position is the same as a geometry position of a current transform block and occupancy information of whose parent transform block has a difference from occupancy information of a parent transform block of the current transform block less than or equal to Q (a second threshold), found in a reference picture/block/slice, may be selected as a corresponding reference block (where Q ranges from 0 to 8).

Exemplarily, in some embodiments, in terms of searching for the reference block based on the preset search strategy, a transform block whose parent transform block has the same geometry position as a parent transform block of a current transform block and whose occupancy information has a difference from occupancy information of the current transform block less than or equal to J, found in a reference picture/block/slice, may be selected as a corresponding reference block (where J ranges from 0 to 8).

Exemplarily, in some embodiments, in terms of searching for the reference block based on the preset search strategy, a transform block found in a reference picture/block/slice may be selected as a corresponding reference block, where a geometry position of a parent transform block of the transform block is the same as a geometry position of a parent transform block of a current transform block and occupancy information of the parent transform block of the transform block has a difference from occupancy information of a parent transform block of the current transform block less than or equal to Q (a second threshold) (where Q ranges from 0 to 8).

It may be noted that in embodiments of the disclosure, in terms of determining the reference block, based on the preset search strategy, one search method may be used for searching in the reference unit(s) in the reference list, or multiple search methods may be used for searching in the reference unit(s) in the reference list. This disclosure is not limited in this regard.

At 105, an attribute transform value of the current block is determined according to an attribute prediction transform value of the reference block.

In embodiments of the disclosure, after the reference block of the current block in the current RAHT layer is determined according to the geometry information of the current block in the current RAHT layer and the reference unit, the attribute transform value of the current block may be further determined according to the attribute prediction transform value of the reference block.

Further, in embodiments of the disclosure, the bitstream may be decoded to determine an attribute transform residual value of the current block.

Further, in embodiments of the disclosure, in terms of determining the attribute transform value of the current block according to the attribute prediction transform value of the reference block, an attribute prediction transform value of the current block may be first determined according to the attribute prediction transform value of the reference block, and then the attribute transform value of the current block may be determined according to the attribute transform residual value and the attribute prediction transform value of the current block.

It may be noted that in embodiments of the disclosure, the attribute transform value of the current block may be determined based on a sum of the attribute transform residual value of the current block and the attribute prediction transform value of the current block.

Further, in embodiments of the disclosure, when no reference block exists in the reference unit, a neighbouring transform block of the current block is determined. Then, an attribute prediction transform value of the current block is determined according to an attribute transform value of the neighbouring transform block. Finally, the attribute transform value of the current block may be determined according to the attribute transform residual value and the attribute prediction transform value of the current block.

It may be noted that in embodiments of the disclosure, if no reference block exists in the reference unit, i.e., no reference block corresponding to the current block is found after searching in the reference unit in the reference list according to the preset search strategy, then it may be determined that an inter prediction transform block of the current block is invalid, and thus an attribute transform prediction value of the current block needs to be determined according to an attribute prediction transform value of an intra neighbouring transform block. For example, an attribute prediction transform value of the neighbouring transform block is determined as the attribute prediction transform value of the current block.

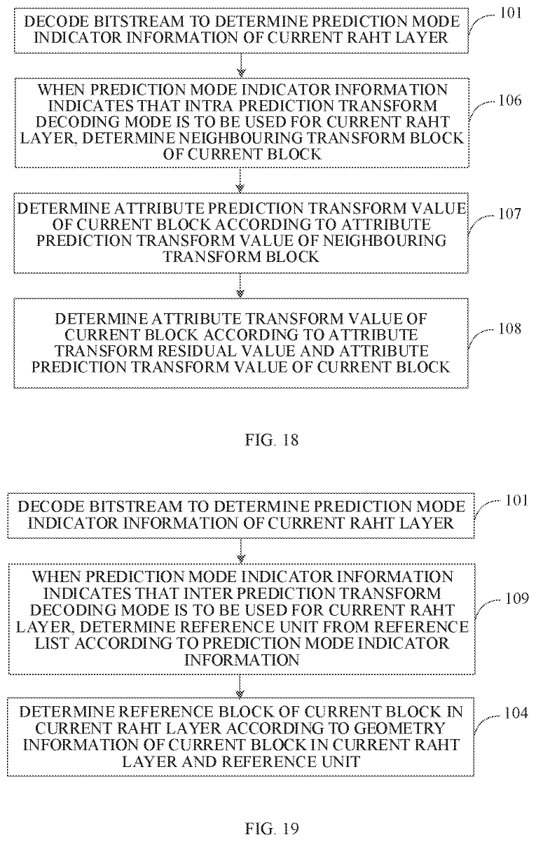

Further, in embodiments of the disclosure, FIG. 18 is schematic flowchart 2 illustrating implementation of a point cloud decoding method provided in embodiments of the disclosure. As illustrated in FIG. 18, after the bitstream is decoded to determine the prediction mode indicator information of the current RAHT layer, i.e., after operations at 101, a point cloud decoding method performed by a decoder may further include the following.

At 106, when the prediction mode indicator information indicates that the intra prediction transform decoding mode is to be used for the current RAHT layer, a neighbouring transform block of the current block is determined.

At 107, an attribute prediction transform value of the current block is determined according to an attribute prediction transform value of the neighbouring transform block.

At 108, the attribute transform value of the current block is determined according to an attribute transform residual value and the attribute prediction transform value of the current block.

In embodiments of the disclosure, after the prediction mode indicator information of the current RAHT layer is determined, when the prediction mode indicator information indicates that the intra prediction transform decoding mode is to be used for the current RAHT layer, the neighbouring transform block of the current block may be first determined. Then, the attribute prediction transform value of the current block is determined according to the attribute prediction transform value of the neighbouring transform block. Finally, the attribute transform value of the current block may be determined according to the attribute transform residual value and the attribute prediction transform value of the current block.

It may be noted that in embodiments of the disclosure, if the prediction mode indicator information indicates that the intra prediction transform decoding mode is to be used for the current RAHT layer, then for any transform block in the current RAHT layer, the intra prediction transform decoding mode may be used for determining a corresponding attribute transform value.

Further, in embodiments of the disclosure, FIG. 19 is schematic flowchart 3 illustrating implementation of a point cloud decoding method provided in embodiments of the disclosure. As illustrated in FIG. 19, after the bitstream is decoded to determine the prediction mode indicator information of the current RAHT layer, i.e., after operations at 101, and before the reference block of the current block in the current RAHT layer is determined according to the geometry information of the current block in the current RAHT layer and the reference unit, i.e., before operations at 104, a point cloud decoding method performed by a decoder may further include the following.

At 109, when the prediction mode indicator information indicates that the inter prediction transform decoding mode is to be used for the current RAHT layer, the reference unit is determined from the reference list according to the prediction mode indicator information.

In embodiments of the disclosure, after the prediction mode indicator information of the current RAHT layer is determined, when the prediction mode indicator information indicates that the inter prediction transform decoding mode is to be used for the current RAHT layer, the reference unit may be further determined from the reference list according to the prediction mode indicator information.

It may be noted that in embodiments of the disclosure, the reference unit may be further determined as follows. A corresponding decoded unit is determined from the reference list based on the prediction mode indicator information of the current RAHT layer.

That is to say, in embodiments of the disclosure, the decoded reference unit corresponding to the current RAHT layer can be determined according to the reference indicator corresponding to the current RAHT layer. Alternatively, the prediction mode indicator information of the current RAHT layer may be directly used for determining the decoded reference unit, and this case, transmission of the reference indicator is no longer needed.

Further, in embodiments of the disclosure, when a value of the prediction mode indicator information is a first value, it is determined that the prediction mode indicator information indicates that an intra prediction transform decoding mode is to be used for the current RAHT layer. When the value of the prediction mode indicator information is not the first value, it is determined that the prediction mode indicator information indicates that the inter prediction transform decoding mode is to be used for the current RAHT layer.

Exemplarily, in some embodiments, when the value of the prediction mode indicator information is a first value, it is determined that the prediction mode indicator information indicates that the intra prediction transform decoding mode is to be used for the current RAHT layer, i.e., a prediction mode for the current RAHT layer is the intra prediction transform decoding mode. When the value of the prediction mode indicator information is not the first value, for one thing, it may be determined that the prediction mode indicator information indicates that the inter prediction transform decoding mode is to be used for the current RAHT layer, i.e., a prediction mode for the current RAHT layer is the inter prediction transform decoding mode, and for another, the reference unit corresponding to the current RAHT layer may be determined from the reference list based on the prediction mode indicator information.

Further, in embodiments of the disclosure, in terms of determining the reference unit from the reference list according to the prediction mode indicator information, when the value of the prediction mode indicator information is j, the j-th decoded unit in the reference list is determined as the reference unit, where j is different from the first value, and j is an integer less than or equal to K.

It may be understood that in embodiments of the disclosure, the prediction mode indicator information of the current RAHT layer may be used for determining the reference unit corresponding to the current RAHT layer. According to the prediction mode indicator information, an order and position of a corresponding reference unit in the reference list may be determined.

Further, in embodiments of the disclosure, in terms of determining the reference unit from the reference list according to the reference indicator, when a value of the reference indicator is j, the j-th decoded unit before the current picture in the reference list is determined as the reference unit, where j is different from the first value, and j is an integer less than or equal to K.

It may be understood that in embodiments of the disclosure, the reference indicator of the current RAHT layer may be used for determining the reference unit corresponding to the current RAHT layer. According to the reference indicator, a relationship between the reference unit corresponding to the current RAHT layer in the reference list and the current picture may be determined.

Further, in embodiments of the disclosure, the bitstream may be further decoded to determine multi-reference prediction indicator information. When the multi-reference prediction indicator information indicates that a multi-reference prediction mode is to be used for the current RAHT layer, and the prediction mode indicator information indicates that the inter prediction transform decoding mode is to be used for the current RAHT layer, the reference block may be determined according to the reference list.

Accordingly, in embodiments of the disclosure, after the bitstream is decoded to determine the multi-reference prediction indicator information, when the multi-reference prediction indicator information indicates that the multi-reference prediction mode is not to be used for the current RAHT layer, and the prediction mode indicator information indicates that the inter prediction transform decoding mode is to be used for the current RAHT layer, the reference block of the current block is determined from a previous decoded picture of the current picture, instead of determining the reference block according to the reference list. Then, the attribute transform value of the current block is determined according to the attribute prediction transform value of the reference block.

It may be noted that in embodiments of the disclosure, the multi-reference prediction indicator information is used for determining whether to use multiple decoded units for inter prediction. The multi-reference prediction indicator information may be determined and transmitted by the encoding end to the decoding end via the bitstream.

It may be noted that in embodiments of the disclosure, in terms of determining according to the multi-reference prediction indicator information whether the reference block is determined according to the reference list, a value of the multi-reference prediction indicator information may be first determined, and then whether to use the reference list for inter prediction may be further determined according to the value of the multi-reference prediction indicator information.

Exemplarily, in some embodiments, when the value of the multi-reference prediction indicator information is a first value, it is determined that the multi-reference prediction indicator information indicates that the reference list is to be used for inter prediction. When the value of the multi-reference prediction indicator information is a second value, it is determined that the multi-reference prediction indicator information indicates that the reference list is not to be used for inter prediction.

It may be further noted that in embodiments of the disclosure, the first value is different from the second value, and the first value and the second value may be in parameter form or in numerical form. Specifically, first prediction mode indicator information and second prediction mode indicator information may be parameters written in a profile, or may be a value of a flag, which is not limited herein. In addition, for the first value and the second value, the first value may be set to 1 and the second value may be set to 0; or, the first value may be set to 0 and the second value may be set to 1; or, the first value may be set to true and the second value may be set to false; or, the first value may be set to false and the second value may be set to true. In embodiments of the disclosure, the first value is set to 0 and the second value is set to 1, which is not limited herein.

Exemplarily, in some embodiments, a 1-bit flag may be used for representing the multi-reference prediction indicator information. The multi-reference prediction indicator information may be used for determining whether to use the reference list, i.e., determining whether to enable multi-picture prediction. That flag may be placed in header information such as an attribute header of a high-level syntax element. That flag is conditionally enabled under some specific conditions. If that flag is not present in a bitstream, a default value of that flag is a fixed value, for example, the first value or the second value.

Accordingly, in some embodiments, the decoding end needs to decode that flag. If that flag is not present in a bitstream, that flag is not decoded, and a default value of that flag is a fixed value, for example, the first value or the second value.

It may be noted that in embodiments of the disclosure, the meaning of that flag, i.e., the multi-reference prediction indicator information, may refer to whether to enable adaptive selection of region adaptive hierarchical inter prediction transform coding technologies for different prediction pictures.

It may be further noted that in embodiments of the disclosure, before attribute decoding of the current RAHT layer, geometry information of nodes in a current point cloud has been completely decoded.

As above mentioned, in embodiments of the disclosure, according to the point cloud decoding method described above in operations at 101 to 109, in terms of using the inter prediction transform decoding mode for the current RAHT layer, the reference unit corresponding to the current RAHT layer may be determined according to the reference list, then the reference block of the current block is determined from the reference unit, and the attribute transform value of the current block is determined according to the attribute prediction transform value of the reference block. Since the reference list includes multiple decoded units, reference can be made to more attribute prediction information during inter attribute prediction for the current block, thereby improving the prediction effect of attribute information.

Therefore, in the decoding method provided in embodiments of the disclosure, by using a reference list including at least one decoded unit, more reference units can be used for inter attribute prediction for the current RAHT layer, i.e., the search range of a prediction picture is expanded during region adaptive hierarchical inter prediction transform decoding. As such, a more accurate prediction value can be generated, thereby improving the prediction effect and the performance of point cloud compression.

It may be noted that in the encoding/decoding method provided in embodiments of the disclosure, based on the preset search strategy, different search methods can be provided during searching for the reference block of the current block, thereby optimizing the search accuracy.

Exemplarily, in some embodiments, the solution provided in embodiments of the disclosure is verified under condition 1: lossless geometry position, lossy attribute, and Cat3-frame, and verification results as illustrated in table 1 may be obtained.

TABLE 1

| | End-to-end | | |
|---|---|---|---|
| Condition 1: lossless | geometry/attribute | | |
| geometry position, lossy | rate-distortion [%] | | |
| attribute, and Cat3-frame | D1 | D2 | Reflectance |
| ford_01_q1mm | 0.0% | 0.0% | −0.6% |
| ford_02_q1mm | 0.0% | 0.0% | −1.2% |
| ford_03_q1mm | 0.0% | 0.0% | −1.0% |
| qnxadas-junction-approach | 0.0% | 0.0% | −5.0% |
| qnxadas-junction-exit | 0.0% | 0.0% | −2.0% |
| qnxadas-motorway-join | 0.0% | 0.0% | −0.3% |
| qnxadas-navigating-bends | 0.0% | 0.0% | −0.8% |
| Average | 0.0% | 0.0% | −1.7% |

As can be seen, the point cloud compression solution provided in embodiments of the disclosure can bring about a huge performance improvement, with the highest dataset achieving a 5% performance improvement in end-to-end attribute rate-distortion.

A decoding method is provided in this embodiment. At the decoding end, the bitstream is decoded to determine the prediction mode indicator information of the current RAHT layer. When the prediction mode indicator information indicates that the inter prediction transform decoding mode is to be used for the current RAHT layer, the bitstream is decoded to determine the reference indicator corresponding to the current RAHT layer. The reference unit corresponding to the current RAHT layer is determined from the reference list according to the reference indicator, where the reference list includes K decoded units, and K is an integer greater than or equal to 1. The reference block of the current block in the current RAHT layer is determined according to the geometry information of the current block in the current RAHT layer and the reference unit. The attribute transform value of the current block is determined according to the attribute prediction transform value of the reference block. That is to say, in embodiments of the disclosure, in terms of using the inter prediction transform decoding mode for the current RAHT layer, the reference unit corresponding to the current RAHT layer may be determined according to the reference list, and the reference block of the current block is determined from the reference unit. Since the constructed reference list includes multiple decoded units, reference can be made to more attribute prediction information during inter attribute prediction for the current RAHT layer, so that the attribute transform value of the current block, determined based on the reference block, can be made more accurate, thereby improving the prediction effect of attribute information and the performance of point cloud compression.

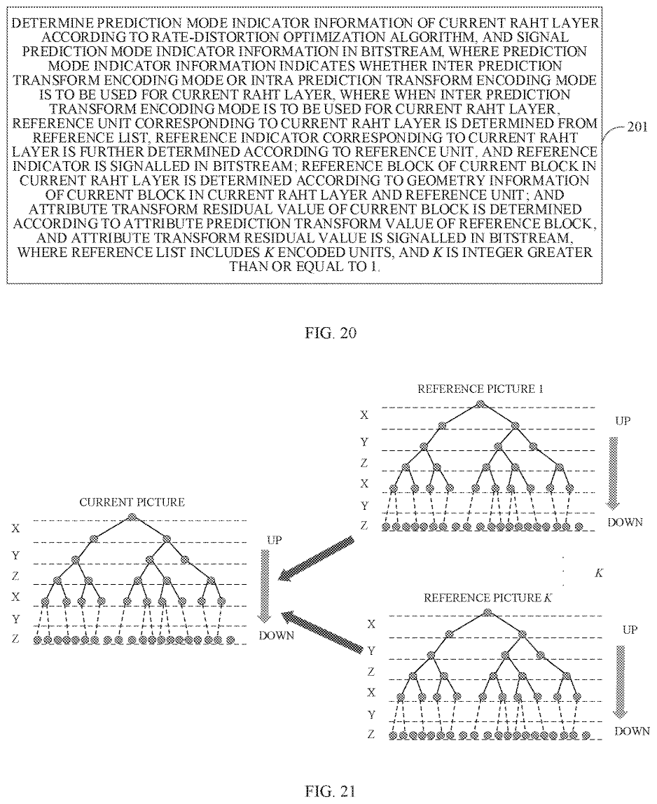

In yet another embodiment of the disclosure, FIG. 20 is a schematic flowchart illustrating implementation of a point cloud encoding method provided in embodiments of the disclosure. As illustrated in FIG. 20, a point cloud encoding method performed by an encoder may include the following.

At 201, prediction mode indicator information of a current RAHT layer is determined according to a rate-distortion optimization algorithm, and the prediction mode indicator information is signalled in a bitstream, where the prediction mode indicator information indicates whether an inter prediction transform encoding mode or an intra prediction transform encoding mode is to be used for the current RAHT layer, where when the inter prediction transform encoding mode is to be used for the current RAHT layer, a reference unit corresponding to the current RAHT layer is determined from a reference list, a reference indicator corresponding to the current RAHT layer is further determined according to the reference unit, and the reference indicator is signalled in the bitstream; a reference block of a current block in the current RAHT layer is determined according to geometry information of the current block in the current RAHT layer and the reference unit; and an attribute transform residual value of the current block is determined according to an attribute prediction transform value of the reference block, and the attribute transform residual value is signalled in the bitstream, where the reference list includes K encoded units, and K is an integer greater than or equal to 1.

In embodiments of the disclosure, the prediction mode indicator information of the current RAHT layer may be first determined. The prediction mode indicator information of the current RAHT layer may be determined according to the rate-distortion optimization algorithm.

It may be noted that, the encoding method in embodiments of the disclosure is applied to a point cloud encoder (also referred to as “encoder” for short). The method may refer to the point cloud encoding method, specifically, a point cloud attribute encoding method.

It may be noted that in embodiments of the disclosure, during RAHT attribute transform, the order of RAHT attribute transform is that the partitioning proceeds from a root node in sequence to the voxel level, specifically, the partitioning is stopped when 1×1×1 unit cube is obtained, thereby completing coding and reconstruction of the entire point cloud attributes. Herein, a layer obtained by performing one down-sampling along the Z direction, the Y direction, and the X direction each time is an RAHT transform layer, i.e., layer. Then, when a 1×1×1 unit cube is obtained, it indicates that the partitioning arrives at the voxel level.

It may be understood that in embodiments of the disclosure, the current RAHT layer may be an RAHT transform layer corresponding to a current point cloud.

It may be noted that in embodiments of the disclosure, the prediction mode indicator information of the current RAHT layer may indicate whether the inter prediction transform encoding mode or the intra prediction transform encoding mode is to be used for the current RAHT layer.

Further, in embodiments of the disclosure, in terms of determining the prediction mode indicator information of the current RAHT layer according to the rate-distortion optimization algorithm, a first cost value corresponding to the intra prediction transform encoding mode and a second cost value corresponding to the inter prediction transform encoding mode may be determined according to the rate-distortion optimization algorithm. Then, the prediction mode indicator information of the current RAHT layer is determined according to the first cost value and the second cost value.

It may be noted that in embodiments of the disclosure, at the encoding end, according to the rate-distortion optimization algorithm, the encoder may use each of two prediction modes (the intra prediction transform encoding mode and the inter prediction transform encoding mode) for predictive coding of attribute information of the current RAHT layer. Finally, the encoder obtains a prediction mode for the current RAHT layer according to the rate-distortion optimization algorithm, and then may determine the prediction mode indicator information of the current RAHT layer.

That is to say, in embodiments of the disclosure, for each RAHT transform layer, at the encoding end, codewords required for directly applying region adaptive hierarchical intra prediction transform coding to the current RAHT layer as well as codewords required for directly applying region adaptive hierarchical inter prediction transform coding to the current RAHT layer are first calculated, a mode with smaller rate-distortion is then selected, and a flag is encoded, i.e., the prediction mode indicator information of the current RAHT layer is encoded.

Further, in embodiments of the disclosure, after the first cost value corresponding to the intra prediction transform encoding mode and the second cost value corresponding to the inter prediction transform encoding mode is determined, the prediction mode indicator information of the current RAHT layer may be determined according to the first cost value and the second cost value.

Further, in embodiments of the disclosure, in terms of determining the prediction mode indicator information of the current RAHT layer according to the first cost value and the second cost value, when it is determined based on the first cost value and the second cost value that the intra prediction transform encoding mode is to be used for the current RAHT layer, a value of the prediction mode indicator information is set to a first value. When it is determined based on the first cost value and the second cost value that the inter prediction transform encoding mode is to be used for the current RAHT layer, the value of the prediction mode indicator information is set to a second value. Finally, the prediction mode indicator information may be signalled in the bitstream and transmitted to the decoding end.

Exemplarily, in some embodiments, in terms of determining the prediction mode indicator information of the current RAHT layer according to the first cost value and the second cost value, if the first cost value is greater than or equal to the second cost value, then a prediction mode for a current point may be determined as the intra prediction transform encoding mode, and accordingly, the value of the prediction mode indicator information may be set to the first value.

Exemplarily, in some embodiments, in terms of determining the prediction mode indicator information of the current RAHT layer according to the first cost value and the second cost value, if the first cost value is less than the second cost value, then a prediction mode for a current point may be determined as the inter prediction transform encoding mode, and accordingly, the value of the prediction mode indicator information may be set to the second value.

It may be noted that in embodiments of the disclosure, after the prediction mode indicator information of the current RAHT layer is determined, the prediction mode indicator information of the current RAHT layer may be further transmitted to the decoding end. As such, the decoding end can determine a prediction coding mode for the current RAHT layer according to the prediction mode indicator information obtained through parsing, and reconstruct and restore attribute information of the current RAHT layer according to a corresponding prediction coding mode.

It may be noted that in embodiments of the disclosure, the prediction mode indicator information of the current RAHT layer may be a syntax element corresponding to attribute header information.

Exemplarily, in some embodiments, the prediction mode indicator information may be placed in an array of a vector form in the attribute header. Each RAHT layer corresponds to one prediction mode indicator information. For example, if a current point cloud corresponds to 10 RAHT layers, then 10 prediction mode indicator information need to be correspondingly included in this vector.

Exemplarily, in some embodiments, the prediction mode indicator information may be determined based on an attribute header corresponding to a slice, or may be determined based on an attribute header corresponding to a frame. This disclosure is not limited in this regard.

It may be understood that in embodiments of the disclosure, the current RAHT layer may be any RAHT transform layer corresponding to a current point cloud, and accordingly, a prediction mode for the current RAHT layer may be determined according to the prediction mode indicator information of the current RAHT layer.

It may be noted that in embodiments of the disclosure, in terms of determining the prediction mode for the current RAHT layer according to the prediction mode indicator information, a value of the prediction mode indicator information may be first determined, and then the prediction mode for the current RAHT layer is further determined according to a value of the prediction mode indicator information.

It may be further noted that in embodiments of the disclosure, the first value is different from the second value, and the first value and the second value may be in parameter form or in numerical form. Specifically, first prediction mode indicator information and second prediction mode indicator information may be parameters written in a profile, or may be a value of a flag, which is not limited herein. In addition, for the first value and the second value, the first value may be set to 1 and the second value may be set to 0; or, the first value may be set to 0 and the second value may be set to 1; or, the first value may be set to true and the second value may be set to false; or, the first value may be set to false and the second value may be set to true. In embodiments of the disclosure, the first value is set to 1 and the second value is set to 0, which is not limited herein.

Further, in embodiments of the disclosure, when the inter prediction transform encoding mode is to be used for the current RAHT layer, the reference unit corresponding to the current RAHT layer may be determined from the reference list, the reference indicator corresponding to the current RAHT layer is further determined according to the reference unit, and the reference indicator is signalled in the bitstream.

It may be noted that in embodiments of the disclosure, the reference list may include K encoded units. K is an integer greater than or equal to 1.

It may be understood that in embodiments of the disclosure, an encoded unit may at least include any one of an encoded picture, a block corresponding to the encoded picture, or a slice corresponding to the encoded picture. Accordingly, the K encoded units at least include: K encoded pictures corresponding to a current picture, or K blocks corresponding to the K encoded pictures, or K slices corresponding to the K encoded pictures.

Exemplarily, in some embodiments, the reference list may include K pictures of a point cloud sequence encoded prior to a current picture. That is, the reference list includes K encoded pictures corresponding to the current picture.

Exemplarily, in some embodiments, the reference list may include K blocks corresponding to a block where a current block is located, in K pictures of a point cloud sequence encoded prior to a current picture. That is, the reference list includes K blocks to which K encoded pictures corresponding to the current picture correspond.

Exemplarily, in some embodiments, the reference list may include K slices corresponding to a block where a current block is located, in K pictures of a point cloud sequence encoded prior to a current picture. That is, the reference list includes K slices to which K encoded pictures corresponding to the current picture correspond.

Further, in embodiments of the disclosure, the K encoded units at least include: N encoded pictures corresponding to the current picture and a fused picture generated based on the N encoded pictures, or N blocks corresponding to the N encoded pictures and a fused block generated based on the N blocks, or N slices corresponding to the N encoded pictures and a fused slice generated based on the N slices. Nis greater than 0 and less than or equal to K.

That is to say, in embodiments of the disclosure, K pictures/slices/blocks in the reference list are not limited to only the first K pictures/slices/blocks corresponding to the current picture, and may also include the first N pictures/slices/blocks corresponding to the current picture as well as a fused picture/slice/block generated based on the first N pictures/slices/blocks. It may be noted that in embodiments of the disclosure, based on the first N encoded pictures/slices/blocks, one picture/slice/block thereof is selected, nearest points are selected in N−1 pictures/slices/blocks other than the one picture/slice/block, and geometry values and attribute values are respectively averaged to obtain a new fused picture/slice/block. For the selection of the nearest point, any one of a nearest point under spatial Morton code distance, a nearest point under spatial Hilbert code distance, or a nearest point under spatial Manhattan distance may be included at least.

Exemplarily, in some embodiments, it is assumed that the first three encoded units corresponding to the current RAHT layer are A0, A1, and A2 respectively, where A0 indicates the 0th picture/slice/block, A1 indicates the 1st picture/slice/block, and A2 indicates the 2nd picture/slice/block. One implementation of a reference list corresponding to the current RAHT layer may be to include these three encoded units A0, A1, and A2. Another implementation of the reference list corresponding to the current RAHT layer may be to include two encoded units A0 and A, where A is a new fused picture/slice/block generated by fusing A1 and A2.

Further, in embodiments of the disclosure, the K encoded units at least include: the fused picture generated based on the N encoded pictures corresponding to the current picture, or the fused block generated based on the N blocks corresponding to the N encoded pictures, or the fused slice generated based on the N slices corresponding to the N encoded pictures. Nis greater than 0 and less than or equal to K.

It may be noted that in embodiments of the disclosure, in terms of generating the fused picture/slice/block based on the N pictures/slices/blocks, the fused picture/slice/block may be determined according to geometry information and/or attribute information of the N pictures/slices/blocks.

It may be understood that in embodiments of the disclosure, based on the first N encoded pictures/slices/blocks, one picture/slice/block thereof is selected, geometry information of the one picture/slice/block is retained as geometry information of a new fused picture/slice/block, and attribute information of the new fused picture/slice/block may be determined according to attribute information of the first N pictures/slices/blocks.

It may be understood that in embodiments of the disclosure, based on the first N encoded pictures/slices/blocks, one picture/slice/block thereof is selected, and attribute information of the one picture/slice/block is retained as attribute information of a new fused picture/slice/block, and geometry information of the new fused picture/slice/block may be determined according to geometry information of the first N pictures/slices/blocks.

It may be understood that in embodiments of the disclosure, based on the first N encoded pictures/slices/blocks, geometry information of a new fused picture/slice/block may be determined according to geometry information of the first N pictures/slices/blocks, and attribute information of the new fused picture/slice/block may be determined according to attribute information of the first N pictures/slices/blocks.

It may be understood that in embodiments of the disclosure, when K is greater than 1, pictures, blocks, or slices for reference during inter attribute prediction for a transform block in the current RAHT layer are no longer limited to only a previous picture of the current picture, and may include a wider selection range of other encoded pictures.

It may be noted that in embodiments of the disclosure, the number K of encoded units may be determined according to a preset threshold.

That is to say, in embodiments of the disclosure, the number K of encoded units in the reference list is not infinite, and the number K of encoded units may be limited by the preset threshold.

Exemplarily, in some embodiments, if the number K of encoded units in the reference list reaches a certain threshold, for example, a preset threshold, then the first added one may be discarded, and the next one may be filled, to maintain a range that does not exceed the preset threshold.

Exemplarily, in some embodiments, if the number K of encoded units in the reference list reaches a certain threshold, for example, a preset threshold, then the reference list may be directly reset to 0 and then accumulated again.

Further, in embodiments of the disclosure, the reference list may correspond to the current RAHT layer, and the reference list may be constructed while performing prediction on attribute information of the current RAHT layer.

It may be noted that in embodiments of the disclosure, an arrangement order and a traversal order of encoded units in the reference list are not limited in the disclosure. That is to say, during attribute prediction for the current RAHT layer, for the encoded units in the constructed reference list, reference can be made to a partitioning order of an RAHT layer or any other order.

Further, in embodiments of the disclosure, when the inter prediction transform encoding mode is to be used for the current RAHT layer, a reference index corresponding to the current RAHT layer may be further determined, and the reference index is signalled in the bitstream and transmitted to the decoding end.

It may be noted that in embodiments of the disclosure, the reference index may be used for determining an index of an encoded unit in the reference list corresponding to the current RAHT layer.

It may be understood that in embodiments of the disclosure, since an order of the encoded unit in the reference list is not limited, a corresponding reference index may be used for determining the index of the encoded unit in the reference list.

It may be noted that in embodiments of the disclosure, the index of the encoded unit may indicate an absolute encoding order or a relative encoding order of the encoded unit.

Exemplarily, in some embodiments, assuming that an encoded unit is an encoded picture, an index of the encoded unit may indicate an absolute order of the encoded picture or may indicate a relative order between the encoded picture and the current picture.

That is to say, in embodiments of the disclosure, a reference picture list serves two purposes. One is to store a display order (i.e., an absolute order) of a reference picture, that is, directly store an absolute value of the display order. The other is to store a relative order of the reference picture, that is, store a difference in display orders between the reference picture and the current picture.

Further, in embodiments of the disclosure, when the inter prediction transform encoding mode is to be used for a current encoding unit, a reference index corresponding to the current encoding unit is determined, and the reference index is signalled in the bitstream. The current encoding unit includes the current RAHT layer, a current picture, a slice in the current picture, or a block in the current picture.

That is to say, in embodiments of the disclosure, the encoding of the index of the encoded unit in the reference list may be performed not only for the current RAHT layer but also for the current picture, the slice in the current picture, or the block in the current picture. This disclosure is not limited in this regard.

Further, in embodiments of the disclosure, in terms of determining the reference unit corresponding to the current RAHT layer from the reference list, for any transform block in the current RAHT layer and a first encoded unit in the reference list, search processing may be performed on the any transform block in the first encoded unit according to a preset search strategy, and a first cost corresponding to the first encoded unit is determined. K costs corresponding to the K encoded units are obtained by traversing the K encoded units in the reference list. Finally, the reference unit corresponding to the current RAHT layer may be determined from the reference list based on the rate-distortion optimization algorithm and the K costs.

It may be noted that in embodiments of the disclosure, for each layer of RAHT transform, if region adaptive hierarchical inter prediction transform coding is selected, then a rate-distortion method needs to be used to select a picture/block/slice with smallest rate-distortion in inter prediction coding at this layer from the reference list as the reference unit.

It may be understood that in embodiments of the disclosure, the first cost corresponding to the first encoded unit may be a sum of cost values obtained after performing search processing on all transform blocks in the current RAHT layer in the first encoded unit. That is, the first cost corresponds to the current RAHT layer.

That is to say, in embodiments of the disclosure, for each encoded unit in the reference list, a sum of cost values corresponding to all transform blocks in the current RAHT layer may be determined, i.e., the K costs corresponding to the K encoded units may be determined. Finally, the reference unit corresponding to the current RAHT layer may be determined from the reference list based on the K costs.

Further, in embodiments of the disclosure, in terms of determining the reference indicator corresponding to the current RAHT layer according to the reference unit, if the reference unit is the i-th encoded unit in the reference list, a value of the reference indicator is set to i, where i is an integer less than or equal to K.

It may be understood that in embodiments of the disclosure, the reference indicator corresponding to the current RAHT layer may be used for determining the reference unit corresponding to the current RAHT layer. According to the reference indicator, an order and position of a corresponding reference unit in the reference list may be determined.

Further, in embodiments of the disclosure, in terms of determining the reference indicator corresponding to the current RAHT layer according to the reference unit, when the reference unit is the i-th encoded unit before a current picture in the reference list, a value of the reference indicator is set to i, where i is an integer less than or equal to K.

It may be understood that in embodiments of the disclosure, the reference indicator corresponding to the current RAHT layer may be used for determining the reference unit corresponding to the current RAHT layer. According to the reference indicator, a relationship between the reference unit corresponding to the current RAHT layer in the reference list and the current picture may be determined.

It may be noted that in embodiments of the disclosure, after the reference indicator corresponding to the current RAHT layer is determined, the reference indicator may be signalled in the bitstream and transmitted to the decoding end.

It may be noted that in embodiments of the disclosure, the reference indicator may be used for determining an encoded reference unit corresponding to the current RAHT layer.

Further, in embodiments of the disclosure, after the reference unit corresponding to the current RAHT layer is determined from the reference list, the reference block of the current block in the current RAHT layer may be further determined according to the geometry information of the current block in the current RAHT layer and the reference unit, and the attribute transform residual value of the current block is determined according to the attribute prediction transform value of the reference block.

It may be noted that in embodiments of the disclosure, if it is determined based on the prediction mode indicator information that the inter prediction transform encoding mode is to be used for the current RAHT layer, then a reference block of a current block to-be-encoded in the current RAHT layer may be further determined according to geometry information of the current block to-be-encoded in the current RAHT layer and the reference unit corresponding to the current RAHT layer.

It may be understood that in embodiments of the disclosure, the current block may be a transform block to-be-encoded in the current RAHT layer.

Further, in embodiments of the disclosure, in terms of determining the reference block of the current block in the current RAHT layer according to the geometry information of the current block in the current RAHT layer and the reference unit, the reference block may be determined, based on the geometry information of the current block, from the reference unit according to a preset search strategy.

It may be noted that in embodiments of the disclosure, the geometry information at least includes any one of: spatial Morton code information, spatial Hilbert code information, spatial coordinate information, spherical coordinate information, or polar coordinate information.

It may be noted that in embodiments of the disclosure, the preset search strategy may be used for searching for and determining an inter reference transform block. The preset search strategy may include any search method for a transform block.

It may be understood that in embodiments of the disclosure, in terms of determining the reference block, search processing may be performed on the reference unit corresponding to the current RAHT layer according to the preset search strategy.

Further, in embodiments of the disclosure, in terms of determining, based on the geometry information of the current block, the reference block from the reference unit according to the preset search strategy, first position information may be first determined according to the geometry information of the current block; and then the reference block may be determined, based on the first position information, from the reference unit according to the preset search strategy.

It may be noted that in embodiments of the disclosure, the first position information may at least include: the geometry information of the current block, and/or geometry information of a parent block of the current block corresponding to the current block, and/or occupancy information of the current block, and/or occupancy information of the parent block of the current block.

That is to say, in embodiments of the disclosure, in terms of determining the reference block, search processing may be performed based on one or more of the geometry information of the current block, the geometry information of the parent block of the current block, the occupancy information of the current block, or the occupancy information of the parent block of the current block.

It may be noted that in embodiments of the disclosure, the preset search strategy at least includes: searching, in the reference unit, for a transform block whose geometry information is the same as the geometry information of the current block, and determining the transform block as the reference block; and/or, searching, in the reference unit, for a parent transform block whose geometry information is the same as the geometry information of the parent block of the current block, and determining the parent transform block as the reference block; and/or, searching, in the reference unit, for a transform block whose geometry information is the same as the geometry information of the current block and whose occupancy information satisfies a first correlation condition with the occupancy information of the current block, and determining the transform block as the reference block; and/or, searching, in the reference unit, for a transform block whose geometry information is the same as the geometry information of the current block and occupancy information of whose corresponding parent transform block satisfies a second correlation condition with the occupancy information of the parent block of the current block, and determining the transform block as the reference block; and/or, searching, in the reference unit, for a transform block whose geometry information is the same as the geometry information of the parent block of the current block and whose occupancy information satisfies the first correlation condition with the occupancy information of the current block, and determining the transform block as the reference block; and/or, searching, in the reference unit, for a parent transform block whose geometry information is the same as the geometry information of the parent block of the current block and whose occupancy information satisfies the second correlation condition with the occupancy information of the parent block of the current block, and determining the parent transform block as the reference block.

It may be noted that in embodiments of the disclosure, the first correlation condition includes: an absolute value of a difference between the occupancy information of the current block and the occupancy information of the transform block being less than or equal to a first threshold. The first threshold is greater than or equal to 0 and less than or equal to 8.

It may be noted that in embodiments of the disclosure, the second correlation condition includes: an absolute value of a difference between the occupancy information of the parent block of the current block and the occupancy information of the parent transform block being less than or equal to a second threshold. The second threshold is greater than or equal to 0 and less than or equal to 8.

Exemplarily, in some embodiments, in terms of searching for the reference block based on the preset search strategy, a transform block whose geometry position (geometry information) is the same as a geometry position of a current transform block (a current block), found in a reference picture/block/slice (an encoded unit), may be selected as a corresponding reference block.

Exemplarily, in some embodiments, in terms of searching for the reference block based on the preset search strategy, a transform block whose parent transform block has the same geometry position as a parent transform block of a current transform block (a parent block of a current block), found in a reference picture/block/slice, may be selected as a corresponding reference block.

Exemplarily, in some embodiments, in terms of searching for the reference block based on the preset search strategy, a transform block whose geometry position is the same as a geometry position of a current transform block and whose occupancy information has a difference from occupancy information of the current transform block less than or equal to J (a first threshold), found in a reference picture/block/slice, may be selected as a corresponding reference block (where J ranges from 0 to 8).

Exemplarily, in some embodiments, in terms of searching for the reference block based on the preset search strategy, a transform block whose geometry position is the same as a geometry position of a current transform block and occupancy information of whose parent transform block has a difference from occupancy information of a parent transform block of the current transform block less than or equal to Q (a second threshold), found in a reference picture/block/slice, may be selected as a corresponding reference block (where Q ranges from 0 to 8).

Exemplarily, in some embodiments, in terms of searching for the reference block based on the preset search strategy, a transform block whose parent transform block has the same geometry position as a parent transform block of a current transform block and whose occupancy information has a difference from occupancy information of the current transform block less than or equal to J, found in a reference picture/block/slice, may be selected as a corresponding reference block (where J ranges from 0 to 8).

Exemplarily, in some embodiments, in terms of searching for the reference block based on the preset search strategy, a transform block found in a reference picture/block/slice may be selected as a corresponding reference block, where a geometry position of a parent transform block of the transform block is the same as a geometry position of a parent transform block of a current transform block and occupancy information of the parent transform block of the transform block has a difference from occupancy information of a parent transform block of the current transform block less than or equal to Q (a second threshold) (where Q ranges from 0 to 8).

It may be noted that in embodiments of the disclosure, in terms of determining the reference block, based on the preset search strategy, one search method may be used for searching in the reference unit in the reference list, or multiple search methods may be used for searching in the reference unit in the reference list. This disclosure is not limited in this regard.

Further, in embodiments of the disclosure, after the reference block of the current block in the current RAHT layer is determined according to the geometry information of the current block in the current RAHT layer and the reference unit, the attribute transform residual value of the current block may be further determined according to the attribute prediction transform value of the reference block.

Further, in embodiments of the disclosure, in terms of determining the attribute transform residual value of the current block according to the attribute prediction transform value of the reference block, an attribute prediction transform value of the current block may be first determined according to the attribute prediction transform value of the reference block, then the attribute transform residual value of the current block may be determined according to the attribute prediction transform value of the reference block, and the attribute transform residual value is signalled in the bitstream.

It may be noted that in embodiments of the disclosure, the attribute transform residual value of the current block may be determined based on a difference between an attribute transform value of the current block and the attribute prediction transform value of the current block.

Further, in embodiments of the disclosure, when no reference block exists in the reference unit, a neighbouring transform block of the current block is determined. Then, an attribute prediction transform value of the current block is determined according to an attribute transform value of the neighbouring transform block. Finally, the attribute transform value of the current block may be determined according to the attribute transform residual value and the attribute prediction transform value of the current block.

It may be noted that in embodiments of the disclosure, if no reference block exists in the reference unit, i.e., no reference block corresponding to the current block is found after searching in the reference unit in the reference list according to the preset search strategy, then it may be determined that an inter prediction transform block of the current block is invalid, and thus an attribute transform prediction value of the current block needs to be determined according to an attribute prediction transform value of an intra neighbouring transform block. For example, an attribute prediction transform value of the neighbouring transform block is determined as the attribute prediction transform value of the current block.

Further, in embodiments of the disclosure, when the intra prediction transform encoding mode is to be used for the current RAHT layer, a neighbouring transform block of the current block is determined. Then, an attribute prediction transform value of the current block is determined according to an attribute prediction transform value of the neighbouring transform block. Finally, the attribute transform residual value may be determined according to an attribute transform value of the current block and the attribute prediction transform value of the current block, and the attribute transform residual value is signalled in the bitstream.

It may be understood that in embodiments of the disclosure, if the intra prediction transform encoding mode is to be used for the current RAHT layer, the neighbouring transform block of the current block may be first determined. Then, the attribute prediction transform value of the current block is determined according to the attribute prediction transform value of the neighbouring transform block. Finally, the attribute transform residual value may be determined according to the attribute transform value of the current block and the attribute prediction transform value of the current block.

It may be noted that in embodiments of the disclosure, if the intra prediction transform encoding mode is to be used for the current RAHT layer, then for any transform block in the current RAHT layer, the intra prediction transform encoding mode may be used for determining a corresponding attribute transform value.

Further, in embodiments of the disclosure, when the intra prediction transform encoding mode is to be used for the current RAHT layer, the prediction mode indicator information of the current RAHT layer may be set, and the prediction mode indicator information is signalled in the bitstream.

Further, in embodiments of the disclosure, when the inter prediction transform encoding mode is to be used for the current RAHT layer, after the reference unit corresponding to the current RAHT layer is determined from the reference list, the prediction mode indicator information of the current RAHT layer may be further determined according to the reference unit, and the prediction mode indicator information is signalled in the bitstream. Then, the reference block of the current block in the current RAHT layer is determined according to the geometry information of the current block in the current RAHT layer and the reference unit. Finally, the attribute transform residual value of the current block is determined according to the attribute prediction transform value of the reference block, and the attribute transform residual value is signalled in the bitstream.

It may be noted that in embodiments of the disclosure, the prediction mode indicator information of the current RAHT layer may be further determined based on the reference unit in the reference list.

That is to say, in embodiments of the disclosure, the reference indicator corresponding to the current RAHT layer can be determined according to the encoded reference unit corresponding to the current RAHT layer. Alternatively, the encoded reference unit corresponding to the current RAHT layer may be directly used for setting the prediction mode indicator information of the current RAHT layer, and in this case, determination and transmission of the reference indicator are no longer needed.

Further, in embodiments of the disclosure, when it is determined that the intra prediction transform encoding mode is to be used for the current RAHT layer, a value of the prediction mode indicator information is set to a first value. When it is determined that the inter prediction transform encoding mode is to be used for the current RAHT layer, the value of the prediction mode indicator information is set according to the reference unit.

That is to say, in embodiments of the disclosure, when the value of the prediction mode indicator information is not the first value, for one thing, it may be determined that the prediction mode indicator information indicates that the inter prediction transform encoding mode is to be used for the current RAHT layer, i.e., a prediction mode for the current RAHT layer is the inter prediction transform encoding mode, and for another, the reference unit corresponding to the current RAHT layer may be determined from the reference list based on the prediction mode indicator information.

Further, in embodiments of the disclosure, in terms of setting the value of the prediction mode indicator information according to the reference unit, when the reference unit is the j-th encoded unit in the reference list, the value of the prediction mode indicator information is set to j, where j is different from the first value, and j is an integer less than or equal to K.

It may be understood that in embodiments of the disclosure, the prediction mode indicator information of the current RAHT layer may be used for determining the reference unit corresponding to the current RAHT layer. According to the prediction mode indicator information, an order and position of a corresponding reference unit in the reference list may be determined.

Further, in embodiments of the disclosure, in terms of setting the value of the prediction mode indicator information according to the reference unit, when the reference unit is the j-th encoded unit before a current picture in the reference list, the value of the prediction mode indicator information is set to j, where j is different from the first value, and j is an integer less than or equal to K.

It may be understood that in embodiments of the disclosure, the prediction mode indicator information of the current RAHT layer may be used for determining the reference unit corresponding to the current RAHT layer. According to the prediction mode indicator information, a relationship between the reference unit corresponding to the current RAHT layer in the reference list and the current picture may be determined.

Further, in embodiments of the disclosure, multi-reference prediction indicator information may be further determined, and the multi-reference prediction indicator information is signalled in the bitstream and transmitted to the decoding end.

It may be noted that in embodiments of the disclosure, when the multi-reference prediction indicator information indicates that a multi-reference prediction mode is to be used for the current RAHT layer, and the inter prediction transform encoding mode is to be used for the current RAHT layer, the reference block may be determined according to the reference list.

Accordingly, in embodiments of the disclosure, after the multi-reference prediction indicator information is determined, when the multi-reference prediction indicator information indicates that the multi-reference prediction mode is not to be used for the current RAHT layer, and the inter prediction transform encoding mode is to be used for the current RAHT layer, the reference block of the current block is determined from a previous encoded picture of the current picture, instead of determining the reference block according to the reference list. Then, the attribute transform value of the current block is determined according to the attribute prediction transform value of the reference block.

It may be noted that in embodiments of the disclosure, the multi-reference prediction indicator information is used for determining whether to use multiple encoded units for inter prediction. The multi-reference prediction indicator information may be determined and transmitted by the encoding end to the decoding end via the bitstream.

It may be noted that in embodiments of the disclosure, in terms of determining the multi-reference prediction indicator information, whether to use the reference list for inter prediction to determine the reference block may be first determined, and then a value of the multi-reference prediction indicator information is set according to a determination result.

Exemplarily, in some embodiments, when it is determined that the reference list is to be used for inter prediction, the value of the multi-reference prediction indicator information is set to a first value. When it is determined that the reference list is not to be used for inter prediction, the value of the multi-reference prediction indicator information is set to a second value.

It may be further noted that in embodiments of the disclosure, the first value is different from the second value, and the first value and the second value may be in parameter form or in numerical form. Specifically, first prediction mode indicator information and second prediction mode indicator information may be parameters written in a profile, or may be a value of a flag, which is not limited herein. In addition, for the first value and the second value, the first value may be set to 1 and the second value may be set to 0; or, the first value may be set to 0 and the second value may be set to 1; or, the first value may be set to true and the second value may be set to false; or, the first value may be set to false and the second value may be set to true. In embodiments of the disclosure, the first value is set to 0 and the second value is set to 1, which is not limited herein.

Exemplarily, in some embodiments, a 1-bit flag may be used for representing the multi-reference prediction indicator information. The multi-reference prediction indicator information may be used for determining whether to use the reference list, i.e., determining whether to enable multi-picture prediction. That flag may be placed in header information such as an attribute header of a high-level syntax element. That flag is conditionally enabled under some specific conditions. If that flag is not present in a bitstream, a default value of that flag is a fixed value, for example, the first value or the second value.

Accordingly, in some embodiments, the decoding end needs to decode that flag. If that flag is not present in a bitstream, that flag is not decoded, and a default value of that flag is a fixed value, for example, the first value or the second value.

It may be noted that in embodiments of the disclosure, the meaning of that flag, i.e., the multi-reference prediction indicator information, may refer to whether to enable adaptive selection of region adaptive hierarchical inter prediction transform coding technologies for different prediction pictures.

It may be further noted that in embodiments of the disclosure, before attribute encoding of the current RAHT layer, geometry information of nodes in a current point cloud has been completely encoded.

As above mentioned, in embodiments of the disclosure, according to the point cloud encoding method described above in operations at 201, in terms of using the inter prediction transform encoding mode for the current RAHT layer, the reference unit corresponding to the current RAHT layer may be determined according to the reference list, then the reference block of the current block is determined from the reference unit, and the attribute transform value of the current block is determined according to the attribute prediction transform value of the reference block. Since the reference list includes multiple encoded units, reference can be made to more attribute prediction information during inter attribute prediction for the current block, thereby improving the prediction effect of attribute information.

Therefore, in the encoding method provided in embodiments of the disclosure, by using a reference list including at least one encoded unit, more reference units can be used for inter attribute prediction for the current RAHT layer, i.e., the search range of a prediction picture is expanded during region adaptive hierarchical inter prediction transform encoding. As such, a more accurate prediction value can be generated, thereby improving the prediction effect and the performance of point cloud compression.

It may be noted that in the encoding method provided in embodiments of the disclosure, based on the preset search strategy, different search methods can be provided during searching for the reference block of the current block, thereby optimizing the search accuracy.

Exemplarily, in some embodiments, the solution provided in embodiments of the disclosure is verified under condition 1: lossless geometry position, lossy attribute, and Cat3-frame, and verification results as illustrated in table 1 may be obtained.

As can be seen, the point cloud compression solution provided in embodiments of the disclosure can bring about a huge performance improvement, with the highest dataset achieving a 5% performance improvement in end-to-end attribute rate-distortion.

An encoding method is provided in this embodiment. At the encoding end, the prediction mode indicator information of the current RAHT layer is determined according to the rate-distortion optimization algorithm, and the prediction mode indicator information is signalled in the bitstream, where the prediction mode indicator information indicates whether the inter prediction transform encoding mode or the intra prediction transform encoding mode is to be used for the current RAHT layer. When the inter prediction transform encoding mode is to be used for the current RAHT layer, the reference unit corresponding to the current RAHT layer is determined from the reference list, the reference indicator corresponding to the current RAHT layer is further determined according to the reference unit, and the reference indicator is signalled in the bitstream. The reference block of the current block in the current RAHT layer is determined according to the geometry information of the current block in the current RAHT layer and the reference unit. The attribute transform residual value of the current block is determined according to the attribute prediction transform value of the reference block, and the attribute transform residual value is signalled in the bitstream. The reference list includes K encoded units, and K is an integer greater than or equal to 1. That is to say, in embodiments of the disclosure, in terms of using the inter prediction transform encoding mode for the current RAHT layer, the reference unit corresponding to the current RAHT layer may be determined according to the reference list, and the reference block of the current block is determined from the reference unit. Since the constructed reference list includes multiple encoded units, reference can be made to more attribute prediction information during inter attribute prediction for the current RAHT layer, so that the attribute transform value of the current block, determined based on the reference block, can be made more accurate, thereby improving the prediction effect of attribute information and the performance of point cloud compression.

Based on the above embodiments, in yet another embodiment of the disclosure, in common technologies, during region adaptive hierarchical inter prediction transform coding, a reference picture in a point cloud sequence is merely a previous picture of a current picture, and due to the limited reference range, the performance is limited. Therefore, a point cloud coding method is provided in embodiments of the disclosure, which can expand a reference range using a multi-picture prediction technology, thereby improving the prediction effect.

Exemplarily, in some embodiments, a 1-bit flag (multi-reference prediction indicator information) may indicate whether to be enabled. That flag is placed in header information such as an attribute header of a high-level syntax element. That flag is conditionally enabled under some specific conditions. If that flag is not present in a bitstream, a default value of that flag is a fixed value.

Similarly, the decoding end needs to decode that flag. If that flag is not present in a bitstream, that flag is not decoded, and a default value of that flag is a fixed value. The meaning of that flag may refer to whether to enable the multi-picture prediction technology.

Exemplarily, in some embodiments, at the encoding end, a reference list may be first constructed. For a point cloud sequence, K pictures of the point cloud sequence encoded prior to a current picture to-be-encoded (a current picture) are stored in the reference list. Alternatively, K blocks or K slices corresponding to K pictures of the point cloud sequence encoded prior to a block where a current transform block to-be-encoded (a current block) of the current picture to-be-encoded is located are stored in the reference list.

It may be noted that in embodiments of the disclosure, for each transform block in each RAHT transform layer (where each layer may include many transform blocks), in terms of applying region adaptive hierarchical inter prediction transform coding, a rate-distortion optimization method may be used for determining a corresponding reference unit from the reference list, that is, a reference picture/block/slice of a current point cloud may be only the S₁-th picture/block/slice or . . . the SK-th picture/block/slice in the reference list.

Exemplarily, in some embodiments, a reference block may be searched for and determined in each picture/block/slice in the reference list according to a preset search strategy, and after K times of repetitions, a corresponding reference unit is selected by using the rate-distortion optimization method. The preset search strategy may include one or more of the following search methods.
1. Searching, in a reference picture/block/slice, for a transform block whose geometry position (geometry information) is the same as a geometry position of a current transform block.
2. Searching, in the reference picture/block/slice, for a transform block whose parent transform block has the same geometry position as a parent transform block of the current transform block.
3. Searching, in the reference picture/block/slice, for a transform block whose geometry position is the same as the geometry position of the current transform block and whose occupancy information has a difference from occupancy information of the current transform block less than or equal to J (where J ranges from 0 to 8).
4. Searching, in the reference picture/block/slice, for a transform block whose geometry position is the same as the geometry position of the current transform block and occupancy information of whose parent transform block has a difference from occupancy information of the parent transform block of the current transform block less than or equal to J (where J ranges from 0 to 8).
5. Searching, in the reference picture/block/slice, for a transform block whose parent transform block has the same geometry position as the parent transform block of the current transform block and whose occupancy information has a difference from the occupancy information of the current transform block less than or equal to J (where J ranges from 0 to 8).
6. Searching, in the reference picture/block/slice, for a transform block, where a geometry position of a parent transform block of the transform block is the same as the geometry position of the parent transform block of the current transform block and occupancy information of the parent transform block of the transform block has a difference from the occupancy information of the parent transform block of the current transform block less than or equal to J (where J ranges from 0 to 8).

Exemplarily, in some embodiments, if no inter prediction transform block is found, then an inter prediction transform block of the current transform block is invalid, and in this case, an attribute prediction transform value of an intra neighbouring transform block is determined as an attribute prediction transform value of a transform block to-be-encoded.

Exemplarily, in some embodiments, if an inter prediction transform block can be found, then an attribute transform value of the inter prediction transform block is an attribute prediction transform value of the current transform block.

It may be noted that in embodiments of the disclosure, for each RAHT transform layer, at the encoding end, codewords required for directly applying region adaptive hierarchical intra prediction transform coding to a current RAHT layer as well as codewords required for directly applying region adaptive hierarchical inter prediction transform coding to the current RAHT layer are first calculated, a mode with smaller rate-distortion is selected, and a flag (prediction mode indicator information of the current RAHT layer) is encoded.

Accordingly, in embodiments of the disclosure, if region adaptive hierarchical inter prediction transform coding is selected, then the rate-distortion method may be further used to select the Si-th picture/block/slice with smallest rate-distortion in inter prediction coding at this layer as a reference picture/block/slice, an index (a reference indicator) of the reference picture/block/slice is encoded, and the Si-th picture/block/slice is further selected as an inter prediction value (a region adaptive hierarchical inter transform coding value) of the reference picture/block/slice.

It may be noted that in embodiments of the disclosure, at the encoding end, a residual value of an attribute transform value (an attribute transform residual value) may be calculated, and the attribute transform residual value is signalled in a bitstream. The attribute transform residual value may be a difference between the attribute transform value and the attribute prediction transform value.

Exemplarily, in some embodiments, at the decoding end, a reference list may be first constructed. For a point cloud sequence, K pictures of the point cloud sequence decoded prior to a current picture to-be-decoded (a current picture) are stored in the reference list. Alternatively, K blocks or K slices corresponding to K pictures of the point cloud sequence decoded prior to a block where a current transform block to-be-decoded (a current block) of the current picture to-be-decoded is located are stored in the reference list.

It may be noted that in embodiments of the disclosure, for each RAHT transform layer, at the decoding end, a flag (prediction mode indicator information of a current RAHT layer) may be decoded to obtain a corresponding mode, i.e., a mode selected for decoding the current RAHT layer.

It may be noted that in embodiments of the disclosure, an attribute transform residual value is decoded.

Exemplarily, in some embodiments, if the mode selected for the current RAHT layer is region adaptive hierarchical intra prediction transform decoding (an intra prediction transform decoding mode), the decoding end applies region adaptive hierarchical intra prediction transform decoding, that is, region adaptive hierarchical intra prediction transform decoding is applied to all transform blocks in a current RAHT transform layer.

Exemplarily, in some embodiments, if the mode selected for the current RAHT layer is region adaptive hierarchical inter prediction transform decoding (an inter prediction transform decoding mode), the decoding end applies region adaptive hierarchical inter prediction transform decoding, that is, region adaptive hierarchical inter prediction transform decoding is applied to all transform blocks in a current RAHT transform layer.

Exemplarily, in some embodiments, if region adaptive hierarchical inter prediction transform decoding is applied to the current RAHT layer, an index (a reference indicator) of a picture/block/slice may be further decoded to obtain the index of the picture/block/slice, that is, the Si-th picture/block/slice is used as a prediction picture, i.e., a reference unit, corresponding to a current picture.

For each block in the current RAHT layer, an inter prediction transform block (a reference block) may be searched for in the Si-th picture/block/slice (the reference unit) according to geometry information of a current transform block to-be-encoded (a current block).

Exemplarily, in some embodiments, the reference block may be searched for and determined according to a preset search strategy. The preset search strategy may include one or more of the following search methods.
1. Searching, in a reference picture/block/slice, for a transform block whose geometry position (geometry information) is the same as a geometry position of the current transform block.
2. Searching, in the reference picture/block/slice, for a transform block whose parent transform block has the same geometry position as a parent transform block of the current transform block.
3. Searching, in the reference picture/block/slice, for a transform block whose geometry position is the same as the geometry position of the current transform block and whose occupancy information has a difference from occupancy information of the current transform block less than or equal to J (where J ranges from 0 to 8).
4. Searching, in the reference picture/block/slice, for a transform block whose geometry position is the same as the geometry position of the current transform block and occupancy information of whose parent transform block has a difference from occupancy information of the parent transform block of the current transform block less than or equal to J (where J ranges from 0 to 8).
5. Searching, in the reference picture/block/slice, for a transform block whose parent transform block has the same geometry position as the parent transform block of the current transform block and whose occupancy information has a difference from the occupancy information of the current transform block less than or equal to J (where J ranges from 0 to 8).
6. Searching, in the reference picture/block/slice, for a transform block, where a geometry position of a parent transform block of the transform block is the same as the geometry position of the parent transform block of the current transform block and occupancy information of the parent transform block of the transform block has a difference from the occupancy information of the parent transform block of the current transform block less than or equal to J (where J ranges from 0 to 8).

Exemplarily, in some embodiments, if no inter prediction transform block is found, then an inter prediction transform block of the current transform block is invalid, and in this case, an attribute prediction transform value of an intra neighbouring transform block is determined as an attribute prediction transform value of a transform block to-be-encoded.

Exemplarily, in some embodiments, if an inter prediction transform block can be found, then an attribute transform value of the inter prediction transform block is an attribute prediction transform value of the current transform block.

It may be noted that in embodiments of the disclosure, at the decoding end, the attribute transform value may be a sum of the attribute transform residual value and the attribute prediction transform value.

Exemplarily, in some embodiments, FIG. 21 is a schematic diagram illustrating point cloud coding provided in embodiments of the disclosure. As illustrated in FIG. 21, based on the construction and use of a reference list, K reference pictures from 1 to K, i.e., K coded point cloud pictures in the reference list, may be used for prediction of attribute information of a current picture.

Therefore, in the encoding method provided in embodiments of the disclosure, by using a reference list including at least one encoded unit, more reference pictures can be used for inter attribute prediction for the current picture, i.e., the search range of a prediction picture is expanded during region adaptive hierarchical inter prediction transform encoding. As such, a more accurate prediction value can be generated, thereby improving the prediction effect and the performance of point cloud compression.

It may be noted that in the encoding method provided in embodiments of the disclosure, based on the preset search strategy, different search methods can be provided during searching for the reference block of the current block, thereby optimizing the search accuracy.

Exemplarily, in some embodiments, the solution provided in embodiments of the disclosure is verified under condition 1: lossless geometry position, lossy attribute, and Cat3-frame, and verification results as illustrated in table 1 may be obtained.

As can be seen, the point cloud compression solution provided in embodiments of the disclosure can bring about a huge performance improvement, with the highest dataset achieving a 5% performance improvement in end-to-end attribute rate-distortion.

A coding method is provided in this embodiment. At the decoding end, a bitstream is decoded to determine prediction mode indicator information of a current RAHT layer. When the prediction mode indicator information indicates that an inter prediction transform decoding mode is to be used for the current RAHT layer, the bitstream is decoded to determine a reference indicator corresponding to the current RAHT layer. A reference unit corresponding to the current RAHT layer is determined from a reference list according to the reference indicator, where the reference list includes K decoded units, and K is an integer greater than or equal to 1. A reference block of a current block in the current RAHT layer is determined according to geometry information of the current block in the current RAHT layer and the reference unit. An attribute transform value of the current block is determined according to an attribute prediction transform value of the reference block. At the encoding end, prediction mode indicator information of a current RAHT layer is determined according to a rate-distortion optimization algorithm, and the prediction mode indicator information is signalled in a bitstream, where the prediction mode indicator information indicates whether an inter prediction transform encoding mode or an intra prediction transform encoding mode is to be used for the current RAHT layer. When the inter prediction transform encoding mode is to be used for the current RAHT layer, a reference unit corresponding to the current RAHT layer is determined from a reference list, a reference indicator corresponding to the current RAHT layer is further determined according to the reference unit, and the reference indicator is signalled in the bitstream. A reference block of a current block in the current RAHT layer is determined according to geometry information of the current block in the current RAHT layer and the reference unit. An attribute transform residual value of the current block is determined according to an attribute prediction transform value of the reference block, and the attribute transform residual value is signalled in the bitstream. The reference list includes K encoded units, and K is an integer greater than or equal to 1. That is to say, in embodiments of the disclosure, in terms of using the inter prediction transform decoding mode for the current RAHT layer, the reference unit corresponding to the current RAHT layer may be determined according to the reference list, and the reference block of the current block is determined from the reference unit. Since the constructed reference list includes multiple decoded units, reference can be made to more attribute prediction information during inter attribute prediction for the current RAHT layer, so that the attribute transform value of the current block, determined based on the reference block, can be made more accurate, thereby improving the prediction effect of attribute information and the performance of point cloud compression.

In still another embodiment of the disclosure, based on the same inventive concept of the foregoing embodiments, FIG. 22 is schematic structural diagram 1 of an encoder provided in embodiments of the disclosure. As illustrated in FIG. 22, the encoder 100 may include a first determining unit 111 and an encoding unit 112. The first determining unit 111 is configured to determine prediction mode indicator information of a current RAHT layer according to a rate-distortion optimization algorithm, where the prediction mode indicator information indicates whether an inter prediction transform encoding mode or an intra prediction transform encoding mode is to be used for the current RAHT layer. The encoding unit 112 is configured to signal the prediction mode indicator information in a bitstream. The first determining unit 111 is further configured to determine a reference unit corresponding to the current RAHT layer from a reference list, and further determine a reference indicator corresponding to the current RAHT layer according to the reference unit, when the inter prediction transform encoding mode is to be used for the current RAHT layer. The reference list includes K encoded units, and K is an integer greater than or equal to 1. The encoding unit 112 is further configured to signal the reference indicator in the bitstream. The first determining unit 111 is further configured to determine a reference block of a current block in the current RAHT layer according to geometry information of the current block in the current RAHT layer and the reference unit; and determine an attribute transform residual value of the current block according to an attribute prediction transform value of the reference block. The encoding unit 112 is further configured to signal the attribute transform residual value in the bitstream.

It may be noted that in embodiments of the disclosure, the encoder 100 may also be considered as a data processing mode (or “entropy encoder”), and is configured to encode a value of a syntax element to-be-encoded.

It may be understood that in embodiments of the disclosure, the “unit” may be part of the circuitry, part of the processor, part of the program or software, etc., and of course may also be a module, or may be non-modular. In addition, various components described in this embodiment may be integrated into one processing unit or may be present as a number of physically separated units, or two or more units may be integrated into one. The integrated unit may take the form of hardware or a software functional module.

If the integrated unit is implemented as a software functional module and not sold or used as a stand-alone product, the integrated unit may be stored in a computer-readable storage medium. Based on such understanding, the technical solution of this embodiment in essential, or a part that contributes to the prior art, or all or part of the technical solution, may be embodied in the form of a software product. The computer software product is stored in a storage medium and includes a number of instructions to enable a computer device (which may be a personal computer, a server, or a network device, etc.) or processor to perform all or part of the operations of the method described in this embodiment. The foregoing storage medium includes a USB stick, a removable hard disk, a read only memory (ROM), a random access memory (RAM), a diskette or a CD-ROM, and other media that may store program codes.

Thus, embodiments of the disclosure provide a computer-readable storage medium, which is applied to the encoder 100. The computer-readable storage medium is configured to store a computer program which, when executed by a first processor, is operable to implement the encoding method described in any one of the foregoing embodiments.

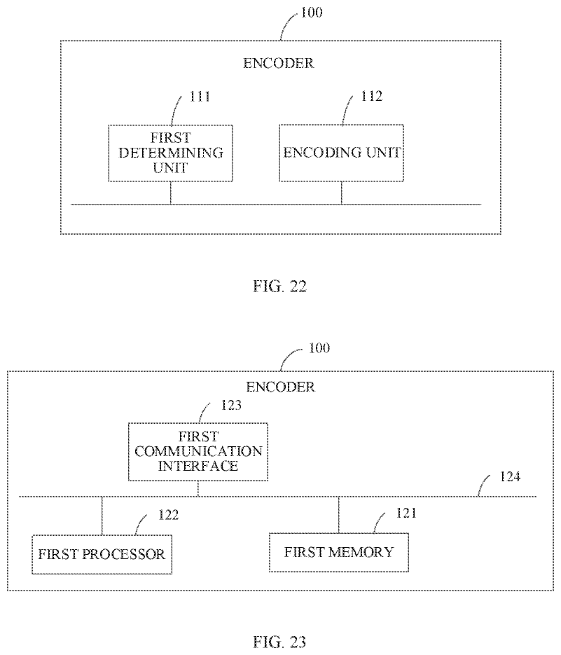

Based on the above structure of the encoder 100 and the computer-readable storage medium, FIG. 23 is schematic structural diagram 2 of an encoder provided in embodiments of the disclosure. As illustrated in FIG. 23, the encoder 100 may include a first memory 121, a first processor 122, a first communication interface 123, and a first bus system 124. The first memory 121, the first processor 122, and the first communication interface 123 are coupled together via the first bus system 124. It may be understood that, the first bus system 124 is configured to enable connection and communication between these components. The first bus system 124 includes a power bus, a control bus, and a status signal bus in addition to a data bus. For the sake of clarity, however, the various buses are labelled as first bus system 124 in FIG. 23.

The first communication interface 123 is configured to receive and transmit signals during information transmission with other external network elements.

The first memory 121 is configured to store a computer program executable by the first processor.

The first processor 122 is configured to: when executing the computer program, determine prediction mode indicator information of a current RAHT layer according to a rate-distortion optimization algorithm, and signal the prediction mode indicator information in a bitstream, where the prediction mode indicator information indicates whether an inter prediction transform encoding mode or an intra prediction transform encoding mode is to be used for the current RAHT layer. When the inter prediction transform encoding mode is to be used for the current RAHT layer, a reference unit corresponding to the current RAHT layer is determined from a reference list, a reference indicator corresponding to the current RAHT layer is further determined according to the reference unit, and the reference indicator is signalled in the bitstream. A reference block of a current block in the current RAHT layer is determined according to geometry information of the current block in the current RAHT layer and the reference unit. An attribute transform residual value of the current block is determined according to an attribute prediction transform value of the reference block, and the attribute transform residual value is signalled in the bitstream. The reference list includes K encoded units, and K is an integer greater than or equal to 1.

It will be appreciated that the first memory 121 in embodiments of the disclosure may be a transitory memory or non-transitory memory, or may include both transitory and non-transitory memory. In particular, the non-transitory memory may be an ROM, a programmable ROM (PROM), an erasable PROM (EPROM), an electrically EPROM (EEPROM), or a flash memory. The transitory memory may be an RAM, which is used as an external cache. By way of illustration, but not limitation, many forms of RAM are available, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM), and a direct Rambus RAM (DRRAM). The first memory 121 of the system and method described in this disclosure is intended to include, but is not limited to, these and any other suitable types of memory.

The first processor 122 may be an integrated circuit chip with signal processing capabilities. During implementation, the operations in the above method may be accomplished by integrated logic circuitry in the hardware of the first processor 122 or by instructions in the form of software. The first processor 122 described above may be a general-purpose processor, a digital signal processor (DSP), an application specific integrated circuit (ASIC), a field programmable gate array (FPGA), or other programmable logic device, discrete gate or transistor logic device, discrete hardware component. The various methods, steps, and logic block diagrams disclosed in embodiments of the disclosure may be implemented or performed. The general-purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers, and other storage media mature in the art. The storage medium is located in the first memory 121, and the first processor 122 reads the information in the first memory 121 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSP Device (DSPD), programmable logic device (PLD), FPGA, general-purpose processor, controller, microcontroller, microprocessor, other electronic unit for performing the functions described in this disclosure, or a combination thereof. For software implementations, the technology described in this disclosure may be implemented by means of modules (e.g, procedures, functions, etc.) that perform the functions described in this disclosure. The software code may be stored in a memory and executed by a processor. The memory may be implemented in the processor or outside the processor.

Optionally, as another embodiment, the first processor 122 is further configured to perform the method described in any one of the foregoing embodiments when executing the computer program.

An encoder is provided in this embodiment. The encoder determines the prediction mode indicator information of the current RAHT layer according to the rate-distortion optimization algorithm, and signals the prediction mode indicator information in a bitstream, where the prediction mode indicator information indicates whether the inter prediction transform encoding mode or the intra prediction transform encoding mode is to be used for the current RAHT layer. When the inter prediction transform encoding mode is to be used for the current RAHT layer, the reference unit corresponding to the current RAHT layer is determined from the reference list, the reference indicator corresponding to the current RAHT layer is further determined according to the reference unit, and the reference indicator is signalled in the bitstream. The reference block of the current block in the current RAHT layer is determined according to the geometry information of the current block in the current RAHT layer and the reference unit. The attribute transform residual value of the current block is determined according to the attribute prediction transform value of the reference block, and the attribute transform residual value is signalled in the bitstream. The reference list includes K encoded units, and K is an integer greater than or equal to 1. That is to say, in embodiments of the disclosure, in terms of using the inter prediction transform decoding mode for the current RAHT layer, the reference unit corresponding to the current RAHT layer may be determined according to the reference list, and the reference block of the current block is determined from the reference unit. Since the constructed reference list includes multiple decoded units, reference can be made to more attribute prediction information during inter attribute prediction for the current RAHT layer, so that the attribute transform value of the current block, determined based on the reference block, can be made more accurate, thereby improving the prediction effect of attribute information and the performance of point cloud compression.

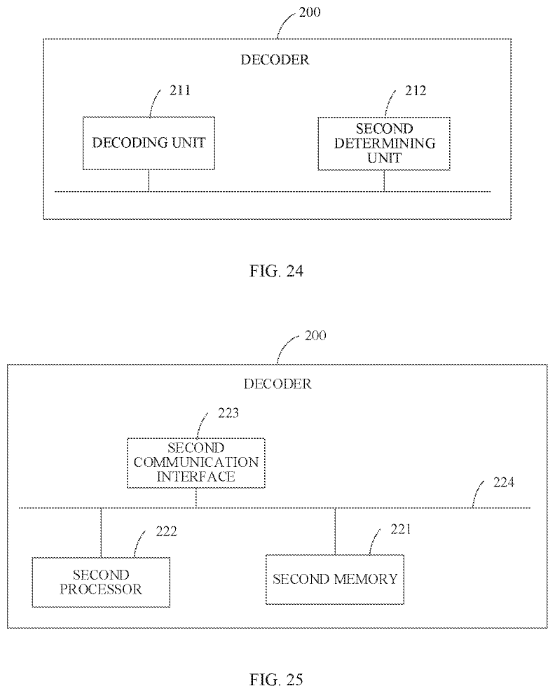

In still another embodiment of the disclosure, based on the same inventive concept of the foregoing embodiments, FIG. 24 is schematic structural diagram 1 of a decoder provided in embodiments of the disclosure. As illustrated in FIG. 24, the decoder 200 may include a decoding unit 211 and a second determining unit 212. The decoding unit 211 is configured to decode a bitstream to determine prediction mode indicator information of a current RAHT layer; and decode the bitstream to determine a reference indicator corresponding to the current RAHT layer, when the prediction mode indicator information indicates that an inter prediction transform decoding mode is to be used for the current RAHT layer. The second determining unit 212 is configured to determine a reference unit corresponding to the current RAHT layer from a reference list according to the reference indicator, where the reference list includes K decoded units, and K is an integer greater than or equal to 1; determine a reference block of a current block in the current RAHT layer according to geometry information of the current block in the current RAHT layer and the reference unit; and determine an attribute transform value of the current block according to an attribute prediction transform value of the reference block.

It may be noted that in embodiments of the disclosure, the decoder 200 may also be considered as a data processing mode (or “entropy decoder”), and is configured to decode a value of a syntax element to-be-decoded.

It may be understood that in this embodiment, the “unit” may be part of the circuitry, part of the processor, part of the program or software, etc., and of course may also be a module, or may be non-modular. In addition, various components described in this embodiment may be integrated into one processing unit or may be present as a number of physically separated units, or two or more units may be integrated into one. The integrated unit may take the form of hardware or a software functional module.

If the integrated unit is implemented as a software functional module and not sold or used as a stand-alone product, the integrated unit may be stored in a computer-readable storage medium. Based on such understanding, this embodiment provides a computer-readable storage medium, which is applied to the decoder 200. The computer-readable storage medium is configured to store a computer program which, when executed by a second processor, is operable to implement the method described in any one of the foregoing embodiments.

Based on the above structure of the decoder 200 and the computer-readable storage medium, FIG. 25 is schematic structural diagram 2 of a decoder provided in embodiments of the disclosure. As illustrated in FIG. 25, the decoder 200 may include a second memory 221, a second processor 222, a second communication interface 223, and a second bus system 224. The second memory 221, the second processor 222, and the second communication interface 223 are coupled together via the second bus system 224. It may be understood that, the second bus system 224 is configured to enable connection and communication between these components. The second bus system 224 includes a power bus, a control bus, and a status signal bus in addition to a data bus. For the sake of clarity, however, the various buses are labelled as second bus system 224 in FIG. 25.

The second communication interface 223 is configured to receive and transmit signals during information transmission with other external network elements.

The second memory 221 is configured to store a computer program executable by the second processor.

The second processor 222 is configured to: when executing the computer program, decode a bitstream to determine prediction mode indicator information of a current RAHT layer; decode the bitstream to determine a reference indicator corresponding to the current RAHT layer, when the prediction mode indicator information indicates that an inter prediction transform decoding mode is to be used for the current RAHT layer; determine a reference unit corresponding to the current RAHT layer from a reference list according to the reference indicator, where the reference list includes K decoded units, and K is an integer greater than or equal to 1; determine a reference block of a current block in the current RAHT layer according to geometry information of the current block in the current RAHT layer and the reference unit; and determine an attribute transform value of the current block according to an attribute prediction transform value of the reference block.

It will be appreciated that the second memory 221 in embodiments of the disclosure may be a transitory memory or non-transitory memory, or may include both transitory and non-transitory memory. In particular, the non-transitory memory may be an ROM, a PROM, an EPROM, an EEPROM, or a flash memory. The transitory memory may be an RAM, which is used as an external cache. By way of illustration, but not limitation, many forms of RAM are available, such as an SRAM, a DRAM, an SDRAM, a DDRSDRAM, an ESDRAM, an SLDRAM, and a DRRAM. The second memory 221 of the system and method described in this disclosure is intended to include, but is not limited to, these and any other suitable types of memory.

The second processor 222 may be an integrated circuit chip with signal processing capabilities. During implementation, the operations in the above method may be accomplished by integrated logic circuitry in the hardware of the second processor 222 or by instructions in the form of software. The second processor 222 described above may be a general-purpose processor, a DSP, an ASIC, an FPGA, or other programmable logic device, discrete gate or transistor logic device, discrete hardware component. The various methods, steps, and logic block diagrams disclosed in embodiments of the disclosure may be implemented or performed. The general-purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers, and other storage media mature in the art. The storage medium is located in the second memory 221, and the second processor 222 reads the information in the second memory 221 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSPD, PLD, FPGA, general-purpose processor, controller, microcontroller, microprocessor, other electronic unit for performing the functions described in this disclosure, or a combination thereof. For software implementations, the technology described in this disclosure may be implemented by means of modules (e.g, procedures, functions, etc.) that perform the functions described in this disclosure. The software code may be stored in a memory and executed by a processor. The memory may be implemented in the processor or outside the processor.

Optionally, as another embodiment, the second processor 222 is further configured to perform the method described in any one of the foregoing embodiments when executing the computer program.

A decoder is provided in this embodiment. The decoder decodes the bitstream to determine the prediction mode indicator information of the current RAHT layer; decodes the bitstream to determine the reference indicator corresponding to the current RAHT layer, when the prediction mode indicator information indicates that the inter prediction transform decoding mode is to be used for the current RAHT layer; determines the reference unit corresponding to the current RAHT layer from the reference list according to the reference indicator, where the reference list includes K decoded units, and K is an integer greater than or equal to 1; determines the reference block of the current block in the current RAHT layer according to the geometry information of the current block in the current RAHT layer and the reference unit; and determines the attribute transform value of the current block according to the attribute prediction transform value of the reference block. That is to say, in embodiments of the disclosure, in terms of using the inter prediction transform decoding mode for the current RAHT layer, the reference unit corresponding to the current RAHT layer may be determined according to the reference list, and the reference block of the current block is determined from the reference unit. Since the constructed reference list includes multiple decoded units, reference can be made to more attribute prediction information during inter attribute prediction for the current RAHT layer, so that the attribute transform value of the current block, determined based on the reference block, can be made more accurate, thereby improving the prediction effect of attribute information and the performance of point cloud compression.

Further, a bitstream is provided in embodiments of the disclosure. The bitstream is generated by performing bit encoding according to information to-be-encoded. The information to-be-encoded at least includes: prediction mode indicator information of a current RAHT layer, an attribute transform residual value of a current block, multi-reference prediction indicator information, or a reference indicator corresponding to the current RAHT layer.

It may be noted that in this disclosure, the terms “include”, “comprise” or any other variant thereof are intended to cover non-exclusive inclusion, such that a process, method, article or apparatus comprising a range of elements includes not only those elements, but also includes other elements that are not explicitly listed or are also inherent to such a process, method, article or apparatus. Without further limitation, an element qualified by the statement “including a . . . ” does not preclude the existence of another identical element in the process, method, article or apparatus including that element.

The above serial numbers of the embodiments of the disclosure are for descriptive purposes only and do not represent the merits of the embodiments.

The methods disclosed in the several method embodiments provided in this disclosure may be combined in any way to obtain new method embodiments without conflict.

The features disclosed in the several product embodiments provided in this disclosure may be combined in any way to obtain new product embodiments without conflict.

The features disclosed in several method or apparatus embodiments provided in this disclosure may be combined in any way to obtain new method embodiments or apparatus embodiments without conflict.

The foregoing is only a specific implementation of the present disclosure, but the scope of protection of the present disclosure is not limited thereto, and any variation or substitution readily conceivable by any person skilled in the art within the technical scope disclosed in the present disclosure shall be covered by the scope of protection of the present disclosure. Accordingly, the scope of protection of this disclosure shall be governed by the scope of protection of the stated claims.

### INDUSTRIAL APPLICABILITY

A coding method, a bitstream, an encoder, a decoder, and a storage medium are provided in embodiments of the disclosure. At the decoding end, a bitstream is decoded to determine prediction mode indicator information of a current RAHT layer. When the prediction mode indicator information indicates that an inter prediction transform decoding mode is to be used for the current RAHT layer, the bitstream is decoded to determine a reference indicator corresponding to the current RAHT layer. A reference unit corresponding to the current RAHT layer is determined from a reference list according to the reference indicator, where the reference list includes K decoded units, and K is an integer greater than or equal to 1. A reference block of a current block in the current RAHT layer is determined according to geometry information of the current block in the current RAHT layer and the reference unit. An attribute transform value of the current block is determined according to an attribute prediction transform value of the reference block. At the encoding end, prediction mode indicator information of a current RAHT layer is determined according to a rate-distortion optimization algorithm, and the prediction mode indicator information is signalled in a bitstream, where the prediction mode indicator information indicates whether an inter prediction transform encoding mode or an intra prediction transform encoding mode is to be used for the current RAHT layer. When the inter prediction transform encoding mode is to be used for the current RAHT layer, a reference unit corresponding to the current RAHT layer is determined from a reference list, a reference indicator corresponding to the current RAHT layer is further determined according to the reference unit, and the reference indicator is signalled in the bitstream. A reference block of a current block in the current RAHT layer is determined according to geometry information of the current block in the current RAHT layer and the reference unit. An attribute transform residual value of the current block is determined according to an attribute prediction transform value of the reference block, and the attribute transform residual value is signalled in the bitstream. The reference list includes K encoded units, and K is an integer greater than or equal to 1. That is to say, in embodiments of the disclosure, in terms of using the inter prediction transform decoding mode for the current RAHT layer, the reference unit corresponding to the current RAHT layer may be determined according to the reference list, and the reference block of the current block is determined from the reference unit. Since the constructed reference list includes multiple decoded units, reference can be made to more attribute prediction information during inter attribute prediction for the current RAHT layer, so that the attribute transform value of the current block, determined based on the reference block, can be made more accurate, thereby improving the prediction effect of attribute information and the performance of point cloud compression.

What is claimed is:

1. A point cloud decoding method, performed by a decoder and comprising:
decoding a bitstream to determine prediction mode indicator information of a current region adaptive hierarchical transform (RAHT) layer;
in response to the prediction mode indicator information indicating that an inter prediction transform decoding mode is to be used for the current RAHT layer, decoding the bitstream to determine a reference indicator corresponding to the current RAHT layer;
determining a reference unit corresponding to the current RAHT layer from a reference list according to the reference indicator, wherein the reference list comprises K decoded units, and K is an integer greater than or equal to 1;
determining a reference block of a current block in the current RAHT layer according to geometry information of the current block in the current RAHT layer and the reference unit; and
determining an attribute transform value of the current block according to an attribute prediction transform value of the reference block.

2. The method of claim 1, wherein
the K decoded units at least comprise: K decoded pictures corresponding to a current picture, or K blocks corresponding to the K decoded pictures, or K slices corresponding to the K decoded pictures; or
the K decoded units at least comprise: N decoded pictures corresponding to the current picture and a fused picture generated based on the N decoded pictures, or N blocks corresponding to the N decoded pictures and a fused block generated based on the N blocks, or N slices corresponding to the N decoded pictures and a fused slice generated based on the N slices, wherein N is greater than 0 and less than or equal to K.

3. The method of claim 2, wherein determining the reference block of the current block in the current RAHT layer according to the geometry information of the current block in the current RAHT layer and the reference unit comprises:
determining, based on the geometry information of the current block, the reference block from the reference unit according to a preset search strategy.

4. The method of claim 3, wherein determining, based on the geometry information of the current block, the reference block from the reference unit according to the preset search strategy comprises:
determining first position information according to the geometry information of the current block in the current RAHT layer; and
determining, based on the first position information, the reference block from the reference unit according to the preset search strategy.

5. The method of claim 4, wherein
the first position information at least comprises: the geometry information of the current block, and/or geometry information of a parent block of the current block corresponding to the current block, and/or occupancy information of the current block, and/or occupancy information of the parent block of the current block.

6. The method of claim 5, wherein the preset search strategy at least comprises:
searching, in the reference unit, for a transform block whose geometry information is the same as the geometry information of the current block, and determining the transform block as the reference block; and/or
searching, in the reference unit, for a parent transform block whose geometry information is the same as the geometry information of the parent block of the current block, and determining the parent transform block as the reference block; and/or
searching, in the reference unit, for a transform block whose geometry information is the same as the geometry information of the current block and whose occupancy information satisfies a first correlation condition with the occupancy information of the current block, and determining the transform block as the reference block; and/or
searching, in the reference unit, for a transform block whose geometry information is the same as the geometry information of the current block and occupancy information of whose corresponding parent transform block satisfies a second correlation condition with the occupancy information of the parent block of the current block, and determining the transform block as the reference block; and/or
searching, in the reference unit, for a transform block whose geometry information is the same as the geometry information of the parent block of the current block and whose occupancy information satisfies the first correlation condition with the occupancy information of the current block, and determining the transform block as the reference block; and/or
searching, in the reference unit, for a parent transform block whose geometry information is the same as the geometry information of the parent block of the current block and whose occupancy information satisfies the second correlation condition with the occupancy information of the parent block of the current block, and determining the parent transform block as the reference block.

7. The method of claim 6, wherein
the first correlation condition comprises: an absolute value of a difference between the occupancy information of the current block and the occupancy information of the transform block being less than or equal to a first threshold, wherein the first threshold is greater than or equal to 0 and less than or equal to 8.

8. The method of claim 6, wherein
the second correlation condition comprises: an absolute value of a difference between the occupancy information of the parent block of the current block and the occupancy information of the parent transform block being less than or equal to a second threshold, wherein the second threshold is greater than or equal to 0 and less than or equal to 8.

9. The method of claim 1, wherein
the geometry information at least comprises any one of: spatial Morton code information, spatial Hilbert code information, spatial coordinate information, spherical coordinate information, or polar coordinate information.

10. The method of claim 1, further comprising:
decoding the bitstream to determine an attribute transform residual value of the current block.

11. The method of claim 10, further comprising:
determining a neighbouring transform block of the current block, in response to existence of no reference block in the reference unit;
determining an attribute prediction transform value of the current block according to an attribute transform value of the neighbouring transform block; and
determining the attribute transform value of the current block according to the attribute transform residual value and the attribute prediction transform value of the current block.

12. The method of claim 10, wherein determining the attribute transform value of the current block according to the attribute prediction transform value of the reference block comprises:
determining an attribute prediction transform value of the current block according to the attribute prediction transform value of the reference block; and
determining the attribute transform value of the current block according to the attribute transform residual value and the attribute prediction transform value of the current block.

13. The method of claim 1, wherein determining the reference unit corresponding to the current RAHT layer from the reference list according to the reference indicator comprises:
determining an i-th decoded unit in the reference list as the reference unit, in response to a value of the reference indicator being i, wherein i is an integer less than or equal to K.

14. The method of claim 2, wherein determining the reference unit corresponding to the current RAHT layer from the reference list according to the reference indicator comprises:
determining an i-th decoded unit before the current picture in the reference list as the reference unit, in response to a value of the reference indicator being i, wherein i is an integer less than or equal to K.

15. The method of claim 1, further comprising:
in response to a value of the prediction mode indicator information being a first value, determining that the prediction mode indicator information indicates that an intra prediction transform decoding mode is to be used for the current RAHT layer; and
in response to the value of the prediction mode indicator information being a second value, determining that the prediction mode indicator information indicates that the inter prediction transform decoding mode is to be used for the current RAHT layer.

16. The method of claim 2, further comprising:
in response to a value of the prediction mode indicator information being a first value, determining that the prediction mode indicator information indicates that an intra prediction transform decoding mode is to be used for the current RAHT layer; and
in response to the value of the prediction mode indicator information being not the first value, determining that the prediction mode indicator information indicates that the inter prediction transform decoding mode is to be used for the current RAHT layer.

17. The method of claim 16, further comprising:
determining the reference unit from the reference list according to the prediction mode indicator information, in response to the prediction mode indicator information indicating that the inter prediction transform decoding mode is to be used for the current RAHT layer.

18. The method of claim 17, wherein determining the reference unit from the reference list according to the prediction mode indicator information comprises:
determining a j-th decoded unit in the reference list as the reference unit, in response to the value of the prediction mode indicator information being j, wherein j is different from the first value, and j is an integer less than or equal to K.

19. A point cloud encoding method, performed by an encoder and comprising:
determining prediction mode indicator information of a current region adaptive hierarchical transform (RAHT) layer according to a rate-distortion optimization algorithm, and signalling the prediction mode indicator information in a bitstream, wherein the prediction mode indicator information indicates whether an inter prediction transform encoding mode or an intra prediction transform encoding mode is to be used for the current RAHT layer;
wherein in response to the inter prediction transform encoding mode being to be used for the current RAHT layer, a reference unit corresponding to the current RAHT layer is determined from a reference list, a reference indicator corresponding to the current RAHT layer is determined according to the reference unit, and the reference indicator is signalled in the bitstream; a reference block of a current block in the current RAHT layer is determined according to geometry information of the current block in the current RAHT layer and the reference unit; and an attribute transform residual value of the current block is determined according to an attribute prediction transform value of the reference block, and the attribute transform residual value is signalled in the bitstream, wherein the reference list comprises K encoded units, and K is an integer greater than or equal to 1.

20. A non-transitory computer-readable storage medium storing a computer program and a bitstream, wherein when executed by a processor, the computer program causes the processor to implement a point cloud encoding method to generate the bitstream, the point cloud encoding method comprising:
determining prediction mode indicator information of a current region adaptive hierarchical transform (RAHT) layer according to a rate-distortion optimization algorithm, and signalling the prediction mode indicator information in a bitstream, wherein the prediction mode indicator information indicates whether an inter prediction transform encoding mode or an intra prediction transform encoding mode is to be used for the current RAHT layer;
wherein in response to the inter prediction transform encoding mode being to be used for the current RAHT layer, a reference unit corresponding to the current RAHT layer is determined from a reference list, a reference indicator corresponding to the current RAHT layer is determined according to the reference unit, and the reference indicator is signalled in the bitstream; a reference block of a current block in the current RAHT layer is determined according to geometry information of the current block in the current RAHT layer and the reference unit; and an attribute transform residual value of the current block is determined according to an attribute prediction transform value of the reference block, and the attribute transform residual value is signalled in the bitstream, wherein the reference list comprises K encoded units, and K is an integer greater than or equal to 1.
